(19) United States
(12) Patent Application Publication
(10) Pub. No.: US 2024/0381230 A1
(43) Pub. Date: Nov. 14, 2024

(54) SYSTEM INFORMATION REQUEST IN A WIRELESS NETWORK

(71) Applicant: Samsung Electronics Co., Ltd., Suwon-si (KR)

(72) Inventor: Anil Agiwal, Allen, TX (US)

(21) Appl. No.: 18/651,472

(22) Filed: Apr. 30, 2024

Related U.S. Application Data
(60) Provisional application No. 63/466,010, filed on May 12, 2023.
(60) Provisional application No. 63/528,831, filed on Jul. 25, 2023.

(51) Int. Cl. H04W 48/14

(52) U.S. Cl. CPC H04W 48/14

(57) ABSTRACT

A user equipment (UE) includes a transceiver configured to receive a system information block 1 (SIB1). The SIB1 includes at least one system information (SI) request configuration including SI request resources for a number of message 1 (Msg1) repetitions. The UE further includes a processor operatively coupled to the transceiver. The processor is configured to select an SI request configuration from the SIB1, and initiate a random access for a SI request using the selected SI request configuration.

### CROSS-REFERENCE TO RELATED APPLICATION(S) AND CLAIM OF PRIORITY

This application claims priority under 35 U.S.C. § 119 (e) to U.S. Provisional Patent Application No. 63/466,010 filed on May 12, 2023, and U.S. Provisional Patent Application No. 63/528,831 filed on Jul. 25, 2023. The above-identified provisional patent applications are hereby incorporated by reference in their entirety.

### TECHNICAL FIELD

This disclosure relates generally to wireless networks. More specifically, this disclosure relates to apparatuses and methods for performing a system information request in a wireless network.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides apparatuses and methods for performing a system information request in a wireless network.

In one embodiment, a user equipment (UE) is provided. The UE includes a transceiver configured to receive a system information block 1 (SIB1). The SIB1 includes at least one system information (SI) request configuration including SI request resources for a number of message 1 (Msg1) repetitions. The UE further includes a processor operatively coupled to the transceiver. The processor is configured to select an SI request configuration from the SIB1, and initiate a random access for a SI request using the selected SI request configuration.

In another embodiment, a method of operating a UE is provided. The method includes receiving a SIB1. The SIB1 includes at least one SI request configuration including SI request resources for a number of Msg1 repetitions. The method further includes selecting an SI request configuration from the SIB1, and initiating a random access for a SI request using the selected SI request configuration.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example of a DRX cycle according to embodiments of the present disclosure;

FIG. 5 illustrates an example of RACH Occasion masking according to embodiments of the present disclosure;

FIG. 6 illustrates another example of RACH Occasion masking according to embodiments of the present disclosure;

FIG. 7 illustrates another example of RACH Occasion masking according to embodiments of the present disclosure;

FIGS. 8A-8C illustrate a method for requesting system information according to embodiments of the present disclosure;

FIGS. 9A-9C illustrate a method for requesting system information according to embodiments of the present disclosure;

FIGS. 10A-10C illustrate a method for requesting system information according to embodiments of the present disclosure;

FIG. 11 illustrates an example of RO grouping according to embodiments of the present disclosure;

FIG. 12 illustrates another example of RO grouping according to embodiments of the present disclosure;

FIG. 13 illustrates a method for selecting ROs for random access according to embodiments of the present disclosure;

FIG. 14 illustrates another method for selecting ROs for random access according to embodiments of the present disclosure; and

FIG. 15 illustrates a method for performing a system information request in a wireless network according to embodiments of the present disclosure.

### DETAILED DESCRIPTION

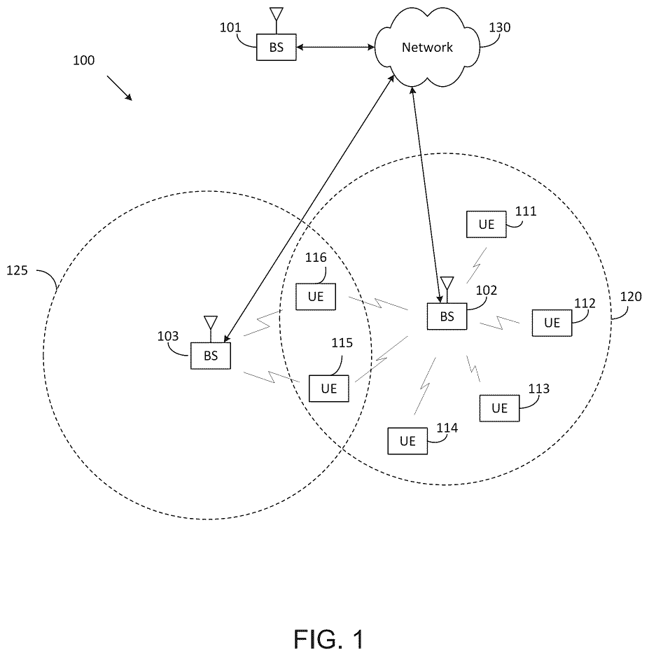

FIGS. 1 through 15, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for performing a system information request. In certain embodiments, one or more of the gNBs 101-103 includes circuitry, programing, or a combination thereof, to support performing a system information request in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

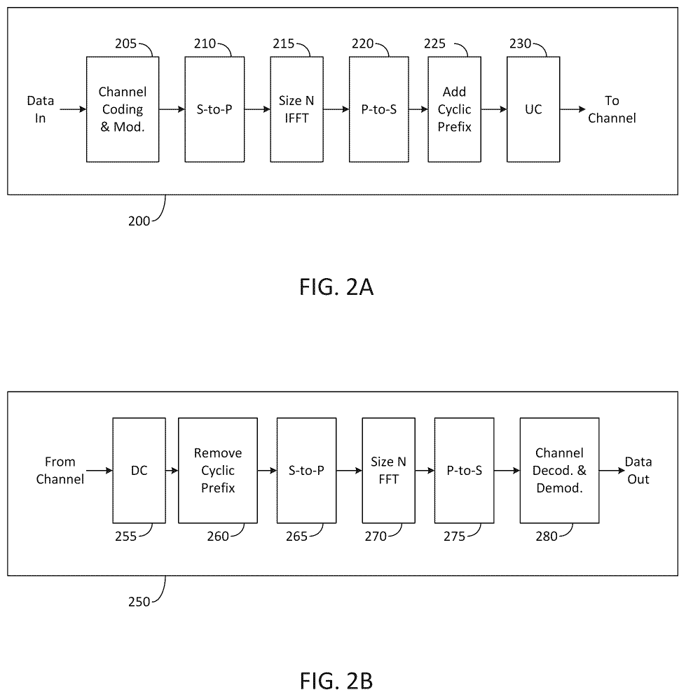

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

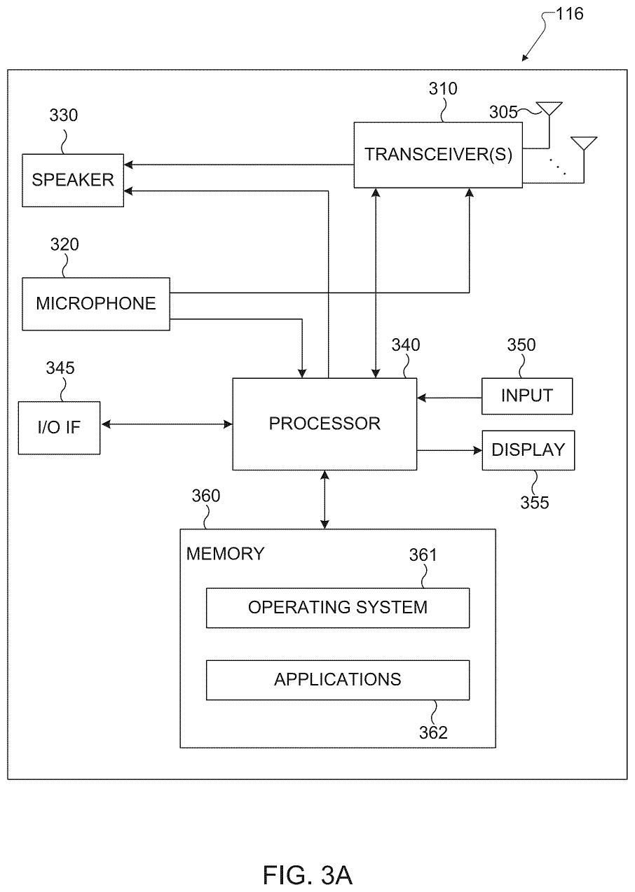

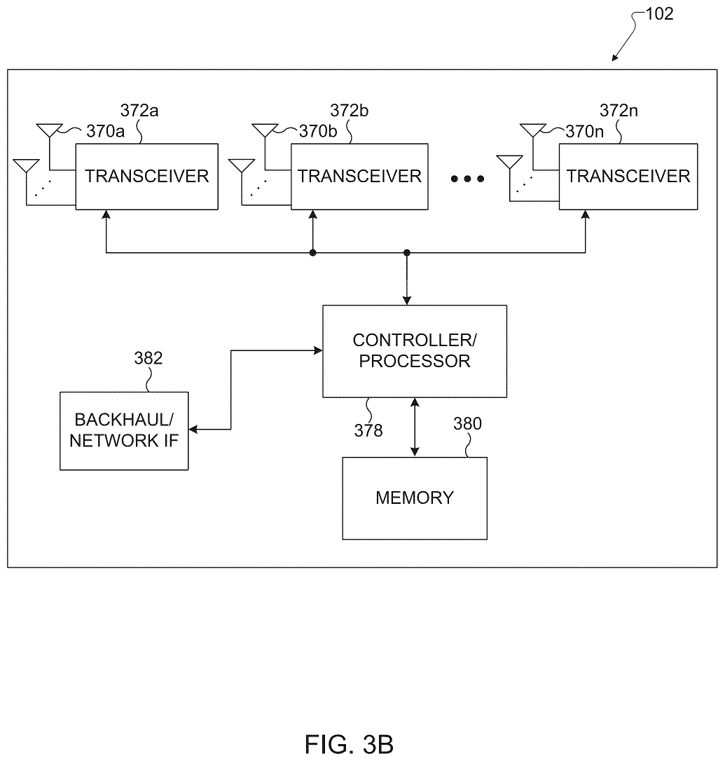

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for performing a system information request as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support performing a system information request as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

In the fifth-generation wireless communication system operating in higher frequency (mmWave) bands, a UE and gNB communicate with each other using beamforming. Beamforming techniques are used to mitigate propagation path losses and to increase the propagation distance for communication at higher frequency bands. Beamforming enhances transmission and reception performance using a high-gain antenna. Beamforming can be classified into Transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing the propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also referred as a transmit (TX) beam. A wireless communication system operating at high frequency uses a plurality of narrow TX beams to transmit signals in the cell as each narrow TX beam provides coverage to a part of cell. The narrower the TX beam, the high the antenna gain and hence the larger the propagation distance of a signal transmitted using beamforming. A receiver can also generate a plurality of receive (RX) beam patterns of different directions. Each of these receive patterns can be also referred as receive (RX) beam.

The fifth generation wireless communication system supports standalone modes of operation as well dual connectivity (DC). In DC a multiple Rx/Tx UE may be configured to utilize resources provided by two different nodes (or NBs) connected via a non-ideal backhaul. One node acts as the Master Node (MN) and the other as the Secondary Node (SN). The MN and SN are connected via a network interface and at least the MN is connected to the core network. New Radio (NR) also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising of the primary cell. For a UE in an RRC_CONNECTED state configured with CA/DC the term ‘serving cells’ is used to denote a set of cells comprising Special Cell(s) and all secondary cells. In NR the term Master Cell Group (MCG) refers to a group of serving cells associated with the Master Node, comprising a PCell and optionally one or more SCells. In NR the term Secondary Cell Group (SCG) refers to a group of serving cells associated with the Secondary Node, comprising a PSCell and optionally one or more SCells. In NR a PCell (primary cell) refers to a serving cell in an MCG, operating on the primary frequency, in which the UE either performs the initial connection establishment procedure or initiates the connection re-establishment procedure. In NR for a UE configured with CA, an Scell is a cell providing additional radio resources on top of the Special Cell. Primary SCG Cell (PSCell) refers to a serving cell in an SCG in which the UE performs random access when performing the Reconfiguration with Sync procedure. For Dual Connectivity operation the term SpCell (i.e., Special Cell) refers to the PCell of the MCG or the PSCell of the SCG. Otherwise, the term Special Cell refers to the PCell.

In the fifth generation wireless communication system, a node B (gNB) or base station in cell broadcast Synchronization Signal and PBCH block (SSB) comprises primary and secondary synchronization signals (PSS, SSS) and system information. System information includes common parameters needed to communicate in the cell. In the fifth generation wireless communication system (also referred as next generation radio or NR), System Information (SI) is divided into the master information block (MIB) and a number of system information blocks (SIBs). The MIB is transmitted on the BCH with a periodicity of 80 ms and repetitions made within 80 ms and the MIB includes parameters that are needed to acquire SIB1 from the cell. The SIB1 is transmitted on the DL-SCH with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to SI message, periodicity, SI-window size) of other SIBs with an indication whether one or more SIBs are only provided on-demand, and, in that case, the configuration needed by the UE to perform the SI request. SIB1 is cell-specific SIB; SIBs other than SIB1 and posSIBs are carried in SystemInformation (SI) messages, which are transmitted on the DL-SCH. Only SIBs or posSIBs having the same periodicity can be mapped to the same SI message. SIBs and posSIBs are mapped to different SI messages. Each SI message is transmitted within periodically occurring time domain windows (referred to as SI-windows with same length for all SI messages). Each SI message is associated with an SI-window and the SI-windows of different SI messages do not overlap. That is to say, within one SI-window only the corresponding SI message is transmitted. An SI message may be transmitted a number of times within the SI-window. Any SIB or posSIB except SIB1 can be configured to be cell specific or area specific, using an indication in SIB1. A cell specific SIB is applicable only within a cell that provides the SIB while an area specific SIB is applicable within an area referred to as the SI area, which comprises one or several cells and is identified by systemInformationAreaID; The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in a RRC_CONNECTED state, the network can provide system information through dedicated signaling using the RRCReconfiguration message, e.g., if the UE has an active BWP with no common search space configured to monitor system information, paging, or upon request from the UE. In an RRC_CONNECTED state, the UE needs to acquire the required SIB(s) only from a PCell. For PSCell and SCells, the network provides the required SI by dedicated signaling, i.e., within an RRCReconfiguration message. Nevertheless, the UE acquires the MIB of the PSCell to get system frame number (SFN) timing of the SCG (which may be different from MCG). Upon change of relevant SI for the SCell, the network releases and adds the concerned SCell. For the PSCell, the required SI can only be changed with Reconfiguration with Sync.

The UE acquires SIB1 from the camped or serving cell. The UE checks the BroadcastStatus bit in SIB1 for an SI message which the UE should acquire. The SI request configuration for supplementary uplink (SUL) is signaled by the gNB using the IE si-RequestConfigSUL in SIB1. If the IE si-RequestConfigSUL is not present in SIB1, the UE considers that the SI request configuration for the SUL is not signaled by the gNB. The SI request configuration for normal uplink (NUL) is signaled by the gNB using the IE si-RequestConfig in SIB1. If the IE si-RequestConfig is not present in SIB1, the UE considers that the SI request configuration for the NUL is not signaled by the gNB. If the SI message which the UE should acquire is not being broadcasted (i.e., BroadcastStatus bit is set to zero), the UE initiates transmission of an SI request. The procedure for an SI request transmission is as follows:
If a SI request configuration is signaled by the gNB for a SUL, and the criteria to select the SUL is met (i.e., RSRP derived from SSB measurements of camped or serving cell <rsrp-ThresholdSSB-SUL, where rsrp-ThresholdSSB-SUL is signaled by the gNB [e.g., in broadcast signaling such as SIB1]), the UE initiates transmission of the SI request based on a Msg1 based SI request on the SUL. In other words, the UE initiates a random-access procedure using the PRACH preamble(s) and PRACH resource(s) in the SI request configuration of the SUL. The UE transmits a Msg1 (i.e., a random-access preamble) and waits for acknowledgement for the SI request. Random access resources (PRACH preamble(s) and PRACH occasions(s)) indicated in the SI request configuration of the SUL are used for the Msg1. The Msg1 is transmitted on the SUL. If acknowledgement for the SI request is received, the UE monitors the SI window of the requested SI message in one or more SI period(s) of that SI message.
Otherwise, if a SI request configuration is signaled by the gNB for a NUL and the criteria to select the NUL is met (i.e., the NUL is selected if the SUL is supported in the camped or serving cell and RSRP derived from SSB measurements of the camped or serving cell >=rsrp-ThresholdSSB-SUL; or the NUL is selected if the SUL is not supported in serving cell), the UE initiates transmission of an SI request based on a Msg1 based SI request on the NUL. In other words, the UE initiates a random access procedure using the PRACH preamble(s) and PRACH resource(s) in the SI request configuration of the NUL. The UE transmits a Msg1 (i.e., a random access preamble) and waits for acknowledgement for the SI request. Random access resources (PRACH preamble(s) and PRACH occasions(s)) indicated in the SI request configuration of the NUL are used for the Msg1. The Msg1 is transmitted on the NUL. If acknowledgement for the SI request is received, the UE monitors the SI window of the requested SI message in one or more SI period(s) of that SI message.
Otherwise, the UE initiates transmission of an SI request based on a Msg3 based SI request. In other words, UE initiates transmission of a RRCSystemInfoRequest message. The UE transmits a Msg1 (i.e., a random access preamble) and waits for a random access response. Common random access resources (PRACH preamble(s) and PRACH occasions(s)) are used for the Msg1. In the UL grant received in the random access response, the UE transmits a RRCSystemInfoRequest message and waits for acknowledgement for the SI request (i.e., a RRCSystemInfoRequest message). If acknowledgement for the SI request (i.e., a RRCSystemInfoRequest message) is received, the UE monitors the SI window of the requested SI message in one or more SI period(s) of that SI message. Note that if the SUL is configured, the UL carrier for Msg1 transmission will be selected by the UE in a similar manner as selected by the UE for a Msg1 based SI request. The SUL is the selected UL carrier, if RSRP derived from SSB measurements of the camped or serving cell <rsrp-ThresholdSSB-SUL where rsrp-ThresholdSSB-SUL is signaled by the gNB (e.g., in broadcast signaling such as SIB1). The NUL is the selected UL carrier, if RSRP derived from SSB measurements of the camped or serving cell >=rsrp-ThresholdSSB-SUL where rsrp-ThresholdSSB-SUL is signaled by the gNB (e.g., in broadcast signaling such as SIB1).

In the fifth generation wireless communication system, a Physical Downlink Control Channel (PDCCH) is used to schedule downlink (DL) transmissions on a Physical Downlink Shared Channel (PDSCH) and uplink (UL) transmissions on a Physicaly Uplink Shared Channel (PUSCH), where the Downlink Control Information (DCI) on the PDCCH includes: downlink assignments containing at least modulation and coding format, resource allocation, and hybrid-ARQ information related to DL-SCH; and uplink scheduling grants containing at least modulation and coding format, resource allocation, and hybrid-ARQ information related to UL-SCH. In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the PRB(s) and OFDM symbol(s) where the UE may assume no transmission is intended for the UE; transmission of TPC commands for PUCCH and PUSCH; transmission of one or more TPC commands for SRS transmissions by one or more UEs; switching a UE's active bandwidth part; and initiating a random access procedure. A UE monitors a set of PDCCH candidates in the configured monitoring occasions in one or more configured COntrol REsource SETs (CORESETs) according to the corresponding search space configurations. A CORESET comprises of a set of PRBs with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCEs. Different code rates for the control channels are realized by aggregating a different number of CCEs. Interleaved and non-interleaved CCE-to-REG mapping is supported in a CORESET. Polar coding is used for the PDCCH. Each resource element group carrying the PDCCH carries its own DMRS. QPSK modulation is used for the PDCCH.

In the fifth-generation wireless communication system, a list of search space configurations is signaled by the GNB for each configured BWP of the serving cell wherein each search configuration is uniquely identified by a search space identifier. The search space identifier is unique amongst the BWPs of a serving cell. An identifier of search space configuration to be used for a specific purpose such as paging reception, SI reception, random access response reception, etc. is explicitly signaled by the gNB for each configured BWP. In NR a search space configuration comprises the parameters Monitoring-periodicity-PDCCH-slot, Monitoring-offset-PDCCH-slot, Monitoring-symbols-PDCCH-within-slot and duration. A UE determines a PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are there in slots ‘x’ to x+duration where the slot with number ‘x’ in a radio frame with number ‘y’ satisfies the equation below: (y*(number of slots in a radio frame)+x−Monitoring-offset-PDCCH-slot) mod (Monitoring-periodicity-PDCCH-slot)=0;

The starting symbol of a PDCCH monitoring occasion in each slot having a PDCCH monitoring occasion is given by Monitoring-symbols-PDCCH-within-slot. The length (in symbols) of a PDCCH monitoring occasion is given in the corset associated with the search space. The search space configuration includes the identifier of the coreset configuration associated with it. A list of coreset configurations are signaled by the GNB for each configured BWP of the serving cell wherein each coreset configuration is uniquely identified by a coreset identifier. The coreset identifier is unique amongst the BWPs of a serving cell. Note that each radio frame is of 10 ms duration. A Radio frame is identified by a radio frame number or system frame number. Each radio frame comprises several slots wherein the number of slots in a radio frame and duration of slots depends on sub carrier spacing. The number of slots in a radio frame and duration of slots is pre-defined in NR. Each coreset configuration is associated with a list of TCI (Transmission configuration indicator) states. One DL RS ID (SSB or CSI RS) is configured per TCI state. The list of TCI states corresponding to a coreset configuration is signaled by the gNB via RRC signaling. One of the TCI states in a TCI state list is activated and indicated to the UE by the gNB. The TCI state indicates the DL TX beam (the DL TX beam is QCLed with the SSB/CSI RS of the TCI state) used by the GNB for transmission of a PDCCH in the PDCCH monitoring occasions of a search space.

In the fifth-generation wireless communication system bandwidth adaptation (BA) is supported. With BA, the receive and transmit bandwidth of a UE need not be as large as the bandwidth of the cell and can be adjusted: the width can be ordered to change (e.g., to shrink during period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE only has to monitor the PDCCH on the one active BWP i.e., it does not have to monitor the PDCCH on the entire DL frequency of the serving cell. In an RRC connected state, the UE is configured with one or more DL and UL BWPs, for each configured Serving Cell (i.e., PCell or SCell). For an activated Serving Cell, there is always one active UL and DL BWP at any point in time. The BWP switching for a Serving Cell is used to activate an inactive BWP and deactivate an active BWP at a time. The BWP switching is controlled by the PDCCH indicating a downlink assignment or an uplink grant, by the bwp-InactivityTimer, by RRC signaling, or by the MAC entity itself upon initiation of a random-access procedure. Upon addition of an SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL. Upon expiry of the BWP inactivity timer the UE switches from the active DL BWP to the default DL BWP or initial DL BWP (if default DL BWP is not configured). In the RRC IDLE and RRC INACTIVE state the UE transmits/receives to/from the gNB on the initial Uplink BWP and initial DL BWP respectively. For a RedCap UE, the initial Uplink BWP and initial DL BWP for the RedCap UE can be optionally configured which is used by the RedCap UE, if configured.

In the 5G wireless communication system, random access (RA) is supported. Random access (RA) is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by a non-synchronized UE in an RRC CONNECTED state. Several types of random access procedures are supported.

One type of random access procedure supported is a Contention based random access (CBRA). This is also referred as 4 step CBRA. In this type of random access, the UE first transmits a Random Access preamble (also referred as Msg1) and then waits for a Random access response (RAR) in the RAR window. A RAR is also referred to as Msg2. A Next generation node B (gNB) transmits the RAR on a physical downlink shared channel (PDSCH). PDCCH scheduling the PDSCH carrying RAR is addressed to a RA-radio network temporary identifier (RA-RNTI). The RA-RNTI identifies the time-frequency resource (also referred to as a physical RA channel (PRACH) occasion or PRACH transmission (TX) occasion or RA channel (RACH) occasion) in which the RA preamble was detected by the gNB. The RA-RNTI is calculated as follows: RA-RNTI=1+s_id+14*t_id+14*80*f_id+14*80*8*ul_carrier_id, where s_id is the index of the first orthogonal frequency division multiplexing (OFDM) symbol of the PRACH occasion where the UE has transmitted Msg1, i.e., RA preamble; Os s_id<14; t_id is the index of the first slot of the PRACH occasion (0≤t_id<80); f_id is the index of the PRACH occasion within the slot in the frequency domain (0≤ f_id<8), and ul_carrier_id is the UL carrier used for Msg1 transmission (0 for normal UL (NUL) carrier and 1 for supplementary UL (SUL) carrier. Several RARs for various Random-access preambles detected by the gNB can be multiplexed in the same RAR media access control (MAC) protocol data unit (PDU) by the gNB. A RAR in a MAC PDU corresponds to the UE's RA preamble transmission if the RAR includes an RA preamble identifier (RAPID) of the RA preamble transmitted by the UE. If the RAR corresponding to its RA preamble transmission is not received during the RAR window and UE has not yet transmitted the RA preamble for a configurable (configured by the gNB in the RACH configuration) number of times, the UE goes back to the first step, that is select random access resource (preamble/RACH occasion) and transmits the RA preamble. A backoff may be applied before going back to first step.

If the RAR corresponding to its RA preamble transmission is received the UE transmits a message 3 (Msg3) in a UL grant received in the RAR. The Msg3 includes a message such as an RRC connection request, RRC connection re-establishment request, RRC handover confirm, scheduling request, SI request etc. It may include the UE identity (i.e., cell-radio network temporary identifier (C-RNTI) or system architecture evolution (SAE)-temporary mobile subscriber identity (S-TMSI) or a random number). After transmitting the Msg3, the UE starts a contention resolution timer. While the contention resolution timer is running, if the UE receives a physical downlink control channel (PDCCH) addressed to the C-RNTI included in the Msg3, contention resolution is considered successful, the contention resolution timer is stopped, and the RA procedure is completed. While the contention resolution timer is running, if the UE receives a contention resolution MAC control element (CE) including the UE's contention resolution identity (first X bits of common control channel (CCCH) service data unit (SDU) transmitted in Msg3), contention resolution is considered successful, the contention resolution timer is stopped, and the RA procedure is completed. If the contention resolution timer expires and the UE has not yet transmitted the RA preamble for a configurable number of times, the UE goes back to first step i.e., select random access resource (preamble/RACH occasion) and transmits the RA preamble. A backoff may be applied before going back to first step.

Another type of random access procedure supported is a Contention free random access (CFRA). This is also referred as legacy CFRA or 4 step CFRA. The CFRA procedure is used for scenarios such as handover where low latency is required, timing advance establishment for secondary cell (Scell), etc. In CFRA, an Evolved node B (eNB) assigns to the UE a dedicated Random access preamble. The UE transmits the dedicated RA preamble. The ENB transmits the RAR on PDSCH addressed to RA-RNTI. The RAR conveys the RA preamble identifier and timing alignment information. The RAR may also include an UL grant. The RAR is transmitted in a RAR window similar to the contention-based RA (CBRA) procedure. The CFRA is considered successfully completed after receiving the RAR including the RA preamble identifier (RAPID) of the RA preamble transmitted by the UE. In case the RA is initiated for beam failure recovery, CFRA is considered successfully completed if the PDCCH addressed to C-RNTI is received in the search space for beam failure recovery. If the RAR window expires and the RA is not successfully completed and the UE has not yet transmitted the RA preamble for a configurable (configured by the gNB in the RACH configuration) number of times, the UE retransmits the RA preamble.

For certain events such has handover and beam failure recovery if a dedicated preamble(s) are assigned to UE, during first step of random access i.e., during random access resource selection for Msg1 transmission, the UE determines whether to transmit the dedicated preamble or a non-dedicated preamble. Dedicated preambles are typically provided for a subset of SSBs/CSI RSs. If there is no SSB/CSI RS having DL RSRP above a threshold amongst the SSBs/CSI RSs for which contention free random access resources (i.e., dedicated preambles/RACH Occassions [ROs]) are provided by the gNB, the UE selects a non-dedicated preamble. Otherwise, the UE selects a dedicated preamble. So, during the RA procedure, one random access attempt can be CFRA while other random access attempts can be CBRA.

Yet another type of random access procedure supported is a 2 step contention based random access (2 step CBRA). In the first step of 2 step CBRA, the UE transmits a random access preamble on a PRACH and a payload (i.e., MAC PDU) on a PUSCH. The random access preamble and payload transmission is also referred as MsgA. In the second step, after MsgA transmission, the UE monitors for a response from the network (i.e., gNB) within a configured window. The response is also referred as a MsgB. A next generation node B (gNB) transmits the MsgB on a physical downlink shared channel (PDSCH). PDCCH scheduling the PDSCH carrying MsgB is addressed to a MsgB-radio network temporary identifier (MSGB-RNTI). The MSGB-RNTI identifies the time-frequency resource (also referred as physical RA channel (PRACH) occasion or PRACH transmission (TX) occasion or RA channel (RACH) occasion) in which the RA preamble was detected by the gNB. The MSGB-RNTI is calculated as follows: RA-RNTI=1+s_id+14*t_id+14*80*f_id+14*80*8*ul_carrier_id+14×80×8×2, where s_id is the index of the first orthogonal frequency division multiplexing (OFDM) symbol of the PRACH occasion where UE has transmitted Msg1, i.e., RA preamble; 0≤s_id<14; t_id is the index of the first slot of the PRACH occasion (0≤t_id<80); f_id is the index of the PRACH occasion within the slot in the frequency domain (0≤ f_id<8), and ul_carrier_id is the UL carrier used for Msg1 transmission (0 for normal UL (NUL) carrier and 1 for supplementary UL (SUL) carrier.

If a CCCH SDU was transmitted in the MsgA payload, the UE performs contention resolution using the contention resolution information in the MsgB. The contention resolution is successful if the contention resolution identity received in the MsgB matches the first 48 bits of the CCCH SDU transmitted in the MsgA. If a C-RNTI was transmitted in the MsgA payload, the contention resolution is successful if the UE receives a PDCCH addressed to the C-RNTI. If contention resolution is successful, the random access procedure is considered successfully completed. Instead of contention resolution information corresponding to the transmitted MsgA, the MsgB may include fallback information corresponding to the random access preamble transmitted in the MsgA. If the fallback information is received, the UE transmits a Msg3 and performs contention resolution using a Msg4 as in the CBRA procedure. If contention resolution is successful, the random access procedure is considered successfully completed. If contention resolution fails upon fallback (i.e., upon transmitting Msg3), the UE retransmits the MsgA. If the configured window in which the UE monitors network response after transmitting the MsgA expires and UE has not received a MsgB including contention resolution information or fallback information as explained above, the UE retransmits the MsgA. If the random access procedure is not successfully completed even after transmitting the MsgA a configurable number of times, the UE falls back to a 4 step RACH procedure i.e., UE only transmits the PRACH preamble.

The MsgA payload may include one or more of a common control channel (CCCH) service data unit (SDU), dedicated control channel (DCCH) SDU, dedicated traffic channel (DTCH) SDU, buffer status report (BSR) MAC control element (CE), power headroom report (PHR) MAC CE, SSB information, C-RNTI MAC CE, or padding. The MsgA may include a UE ID (e.g., random ID, S-TMSI, C-RNTI, resume ID, etc.) along with a preamble in the first step. The UE ID may be included in the MAC PDU of the MsgA. A UE ID such as C-RNTI may be carried in a MAC CE wherein the MAC CE is included in the MAC PDU. Other UE IDs (such random ID, S-TMSI, C-RNTI, resume ID, etc.) may be carried in a CCCH SDU. The UE ID can be one of a random ID, S-TMSI, C-RNTI, resume ID, IMSI, idle mode ID, inactive mode ID, etc. The UE ID can be different in different scenarios in which the UE performs the RA procedure. When the UE performs RA after power on (before it is attached to the network), then the UE ID is the random ID. When the UE performs RA in an IDLE state after it is attached to network, the UE ID is the S-TMSI. If the UE has an assigned C-RNTI (e.g., in a connected state), the UE ID is the C-RNTI. In case the UE is in INACTIVE state, the UE ID is the resume ID. In addition to the UE ID, some addition control information can be sent in the MsgA. The control information may be included in the MAC PDU of the MsgA. The control information may include one or more of a connection request indication, connection resume request indication, SI request indication, buffer status indication, beam information (e.g., one or more DL TX beam ID(s) or SSB ID(s)), beam failure recovery indication/information, data indicator, cell/BS/TRP switching indication, connection re-establishment indication, reconfiguration complete or handover complete message, etc.

Still another type of random access procedure supported is a 2 step contention free random access (2 step CFRA). In this case the gNB assigns to the UE dedicated Random access preamble(s) and PUSCH resource(s) for MsgA transmission. The RO(s) to be used for preamble transmission may also be indicated. In the first step, the UE transmits the random access preamble on a PRACH and a payload on a PUSCH using the contention free random access resources (i.e., dedicated preamble/PUSCH resource/RO). In the second step, after MsgA transmission, the UE monitors for a response from the network (i.e., gNB) within a configured window. The response is also referred as a MsgB.

The next generation node B (gNB) transmits the MsgB on a physical downlink shared channel (PDSCH). A PDCCH scheduling the PDSCH carrying the MsgB is addressed to a MsgB-radio network temporary identifier (MSGB-RNTI). The MSGB-RNTI identifies the time-frequency resource (also referred as a physical RA channel (PRACH) occasion or PRACH transmission (TX) occasion or RA channel (RACH) occasion) in which the RA preamble was detected by the gNB. The MSGB-RNTI is calculated as follows: RA-RNTI=1+s_id+14*t_id+14*80*f_id+14*80*8*ul_carrier_id+14× 80×8×2, where s_id is the index of the first orthogonal frequency division multiplexing (OFDM) symbol of the PRACH occasion where the UE has transmitted the Msg1, i.e., RA preamble; 0≤s_id<14; t_id is the index of the first slot of the PRACH occasion (0≤t_id<80); f_id is the index of the PRACH occasion within the slot in the frequency domain (0≤ f_id<8), and ul_carrier_id is the UL carrier used for Msg1 transmission (0 for normal UL (NUL) carrier and 1 for supplementary UL (SUL) carrier.

If the UE receives the PDCCH addressed to the C-RNTI, the random access procedure is considered successfully completed. If the UE receives fallback information corresponding to its transmitted preamble, the random access procedure is considered successfully completed.

For certain events such has handover and beam failure recovery if dedicated preamble(s) and PUSCH resource(s) are assigned to the UE, during first step of random access i.e., during random access resource selection for MsgA transmission the UE determines whether to transmit a dedicated preamble or non-dedicated preamble. Dedicated preambles are typically provided for a subset of SSBs/CSI RSs. If there are no SSB/CSI RS having a DL RSRP above a threshold amongst the SSBs/CSI RSs for which contention free random access resources (i.e., dedicated preambles/ROs/PUSCH resources) are provided by the gNB, the UE selects a non-dedicated preamble. Otherwise, the UE selects a dedicated preamble. So, during the RA procedure, one random access attempt can be 2 step CFRA while another random access attempt can be 2 step CBRA.

Upon initiation of a random access procedure, the UE first selects the carrier (SUL or NUL). If the carrier to use for the random-access procedure is explicitly signaled by the gNB, the UE selects the signaled carrier for performing the Random-Access procedure. If the carrier to use for the random-access procedure is not explicitly signaled by gNB, and if the Serving Cell for the Random-Access procedure is configured with a supplementary uplink and if the RSRP of the downlink pathloss reference is less than rsrp-ThresholdSSB-SUL, the UE selects the SUL carrier for performing Random Access procedure. Otherwise, the UE selects the NUL carrier for performing Random Access procedure. Upon selecting the UL carrier, the UE determines the UL and DL BWP for the random access procedure as specified in section 5.15 of TS 38.321. The UE then determines whether to perform 2 step or 4 step RACH for this random access procedure.
If this random access procedure is initiated by a PDCCH order and if the ra-PreambleIndex explicitly provided by the PDCCH is not 0b000000, the UE selects 4 step RACH.
Otherwise, if 2 step contention free random access resources are signaled by the gNB for this random access procedure, the UE selects 2 step RACH.
Otherwise, if 4 step contention free random access resources are signaled by the gNB for this random access procedure, the UE selects 4 step RACH.
Otherwise, if the UL BWP selected for this random access procedure is configured with only 2 step RACH resources, the UE selects 2 step RACH.
Otherwise, if the UL BWP selected for this random access procedure is configured with only 4 step RACH resources, the UE selects 4 step RACH.
Otherwise, if the UL BWP selected for this random access procedure is configured with both 2 step and 4 step RACH resources.
If the RSRP of the downlink pathloss reference is below a configured threshold, the UE selects 4 step RACH. Otherwise, the UE selects 2 step RACH.

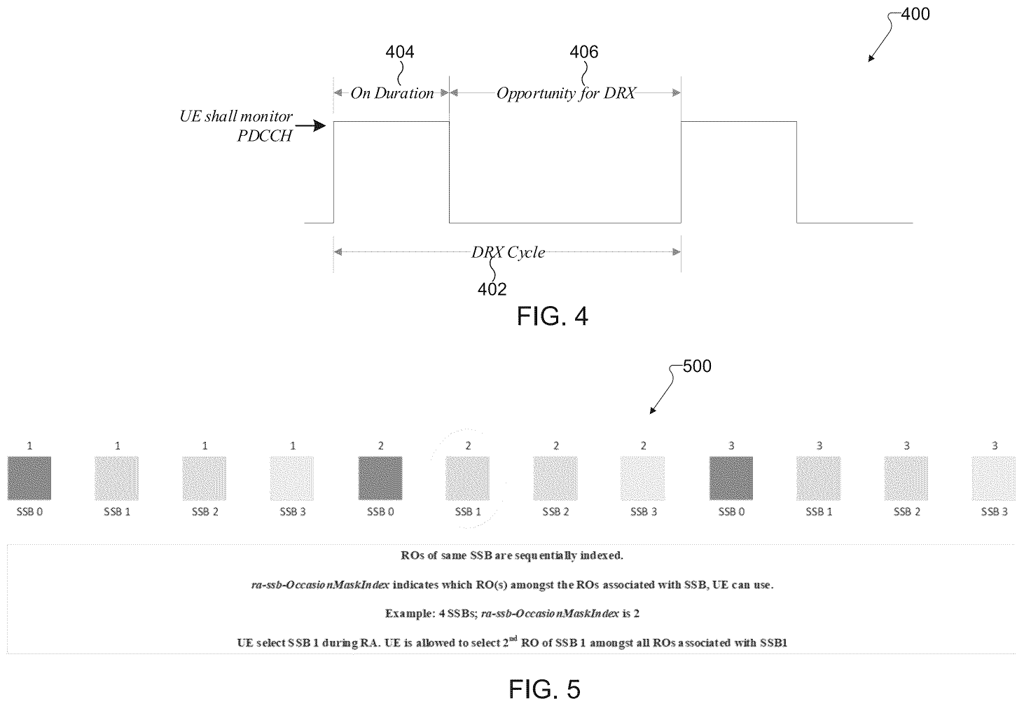

In the fifth generation wireless communication system, the PDCCH monitoring activity of the UE in an RRC connected mode is governed by a connected mode UE specific DRX cycle. When DRX is configured, the UE does not have to continuously monitor PDCCH (addressed to C-RNTI, CI-RNTI, CS-RNTI, INT-RNTI, SFI-RNTI, SP-CSI-RNTI, TPC-PUCCH-RNTI, TPC-PUSCH-RNTI, TPC-SRS-RNTI, AI-RNTI, SL-RNTI, SLCS-RNTI and SL Semi-Persistent Scheduling V-RNTI). DRX is characterized by the following:
on-duration: the duration that the UE waits for, after waking up, to receive PDCCHs. If the UE successfully decodes a PDCCH, the UE stays awake and starts the inactivity timer;
inactivity-timer: the duration that the UE waits to successfully decode a PDCCH, from the last successful decoding of a PDCCH, failing which it can go back to sleep. The UE shall restart the inactivity timer following a single successful decoding of a PDCCH for a first transmission only (i.e., not for retransmissions);
retransmission-timer: the duration until a retransmission can be expected;
cycle: specifies the periodic repetition of the on-duration followed by a possible period of inactivity (see FIG. 4);
active-time: the total duration that the UE monitors PDCCH. This includes the “on-duration” of the DRX cycle, the time UE is performing continuous reception while the inactivity timer has not expired, and the time when the UE is performing continuous reception while waiting for a retransmission opportunity.

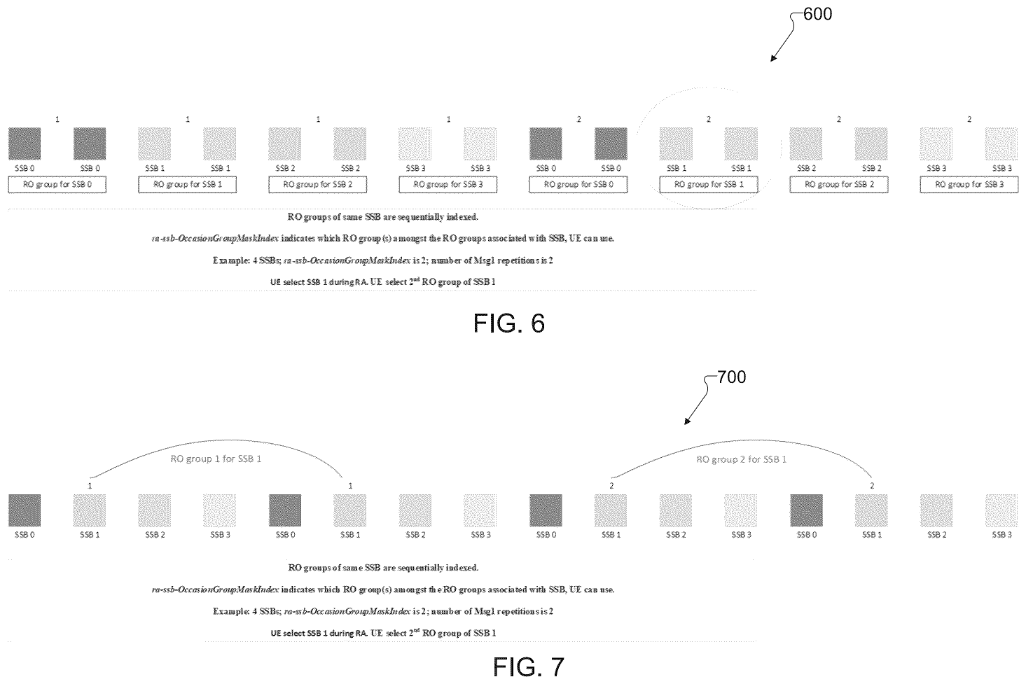

FIG. 4 illustrates an example 400 of a DRX cycle according to embodiments of the present disclosure. The embodiment of a DRX cycle of FIG. 6 is for illustration only. Different embodiments of a DRX cycle could be used without departing from the scope of this disclosure.

In the example of FIG. 4, a DRX cycle 402 includes an on duration 404 and an opportunity for DRX 406.

Although FIG. 4 illustrates an example 400 of a DRX cycle, various changes may be made to FIG. 4. For example, various changes to the on duration, the opportunity for DRX, etc. could be made according to particular needs.

Serving Cells of a MAC entity may be configured by RRC in two DRX groups with separate DRX parameters. When RRC does not configure a secondary DRX group, there is only one DRX group and all Serving Cells belong to that one DRX group. When two DRX groups are configured, each Serving Cell is uniquely assigned to either of the two groups. The DRX parameters that are separately configured for each DRX group are: drx-onDurationTimer, drx-Inactivity Timer. The DRX parameters that are common to the DRX groups are: drx-SlotOffset, drx-RetransmissionTimerDL, drx-RetransmissionTimerUL, drx-LongCycleStartOffset, drx-ShortCycle (optional), drx-ShortCycle Timer (optional), drx-HARQ-RTT-TimerDL, drx-HARQ-RTT-Timer (IL, downlinkHARQ-FeedbackDisabled (optional) and uplinkHARQ-Mode (optional).

When DRX is configured, the Active Time for Serving Cells in a DRX group includes the time while:
drx-onDurationTimer or drx-InactivityTimer configured for the DRX group is running; or
drx-RetransmissionTimerDL, drx-RetransmissionTimerUIL, or drx-Retransmission TimerSL is running on any Serving Cell in the DRX group; or
ra-ContentionResolutionTimer or msgB-Response Window is running; or
a Scheduling Request is sent on PUCCH and is pending. If this Serving Cell is part of a non-terrestrial network, the Active Time is started after the Scheduling Request transmission that is performed when the SR COUNTER is 0 for all the SR configurations with pending SR(s) plus the UE-gNB RTT; or
a PDCCH indicating a new transmission addressed to the C-RNTI of the MAC entity has not been received after successful reception of a random access Response for the random access Preamble not selected by the MAC entity among the contention-based random access Preamble.

In the fifth-generation wireless communication system UEs with reduced capabilities are supported. A UE with reduced capabilities may be referred to as a RedCap UE. A RedCap UE is a UE with following reduced capabilities:
The maximum bandwidth is 20 MHz for FR1 (i.e., frequency range of 410 MHz-7125 MHz), and is 100 MHz for FR2 (i.e., frequency range of 24250 MHz-52600 MHZ). UE features and corresponding capabilities related to UE bandwidths wider than 20 MHz in FR1 or wider than 100 MHz in FR2 are not supported by RedCap UEs;
The maximum mandatory supported DRB (data radio bearer) number is 8;
The mandatory supported PDCP SN (packet data convergence protocol sequence number) length is 12 bits with 18 bits being optional;
The mandatory supported RLC AM SN length is 12 bits with 18 bits being optional;
For FR1, 1 DL MIMO layer if 1 Rx branch is supported, and 2 DL MIMO layers if 2 Rx branches are supported; for FR2, either 1 or 2 DL MIMO layers can be supported, while 2 Rx branches are supported. For FR1 and FR2, UE features and corresponding capabilities related to more than 2 UE Rx branches or more than 2 DL MIMO layers, as well as UE features and capabilities related to more than 1 UE Tx branch, or more than 1 UL MIMO layer are not supported by RedCap UEs;
CA, MR-DC, DAPS, CPAC and IAB (i.e., the RedCap UE is not expected to act as IAB node) related UE features and corresponding capabilities are not supported by RedCap UEs. All other feature groups or components of the feature groups as well as capabilities remain applicable for RedCap UEs the same as non-RedCap UEs, unless indicated otherwise.

An enhanced RedCap (eRedCap) UE is the UE with one or more of the following reduced capabilities in addition to reduced capability defined for RedCap UE.
(a) UE BB bandwidth reduction
   i. 5 MHz BB bandwidth only for PDSCH (for both unicast and broadcast) and PUSCH, with 20 MHz RF bandwidth for UL and DL
   ii. The other physical channels and signals are still allowed to use a BWP up to the 20 MHz maximum UE RF+BB bandwidth.
(b) UE peak data rate reduction

In the fifth-generation wireless communication system, for UL coverage enhancements, repetitions of PRACH transmissions within a single random-access attempt (or PRACH attempt) is considered. For multiple PRACH transmissions within one RACH attempt, the PRACH transmissions are only transmitted over ROs associated with the same SSB/CSI-RS. For multiple PRACH transmissions with same Tx beam in one RACH attempt, transmission power ramping is not applied within one RACH attempt. For multiple PRACH transmissions with same Tx beam, only one RAR window is supported for RAR monitoring for one RACH attempt. For multiple PRACH transmissions with same Tx beam, to differentiate the multiple PRACH transmissions with single PRACH transmission, multiple PRACH transmitted on separate ROs is supported. For multiple PRACH transmissions with same Tx beam, to differentiate the multiple PRACH transmissions with single PRACH transmission, multiple PRACH transmitted with separate preamble on shared ROs is supported. For multiple PRACH transmissions with same Tx beam, the gNB can configure one or multiple values for the number of multiple PRACH transmissions. If multiple values are configured, PRACH resources differentiation between multiple PRACH transmissions with different numbers of multiple PRACH transmissions is supported.

For the initial uplink BWP of a normal uplink carrier (NUL), SI request resources are signaled by the IE si-RequestConfig in SIB1. Except for the configuration in si-RequestConfig, the remaining configuration for a Msg1 based SI request is obtained from the rach-ConfigCommon IE included in the BWP-UplinkCommon IE for the initial uplink BWP of the NUL.

For the initial uplink BWP of the supplementary uplink carrier (SUL), SI request resources are signaled by the IE si-RequestConfigSUL in SIB1. Except for the configuration in si-RequestConfigSUL, the remaining configuration for a Msg1 based SI request is obtained from the rach-ConfigCommon IE included in the BWP-UplinkCommon IE for the initial uplink BWP of the SUL.

For the RedCap specific initial uplink BWP of a normal uplink carrier (NUL), SI request resources are signaled by the IE si-RequestConfigRedCap in SIB1. Except for the configuration in si-RequestConfigredCap, the remaining configuration for a Msg1 based SI request is obtained from the rach-ConfigCommon IE included in the BWP-UplinkCommon IE for the RedCap specific initial uplink BWP of the NUL.

Based on the RACH configuration provided by si-RequestConfig si-RequestConfigSUL/si-RequestConfigRedCap and corresponding rach-ConfigCommon, the UE can transmit a Msg1 (i.e., PRACH preamble) for an SI request, where after transmitting the PRACH preamble the UE waits for response. In order to enhance coverage, transmitting the Msg1 for the SI request multiple times before receiving a response is beneficial. The current configuration does not support transmitting the SI request times before receiving response. The present disclosure provides enhancements that overcome these issues.

RO masking is supported for contention free random access. ROs associated with the same SSB are sequentially indexed. ra-ssb-OccasionMaskIndex indicates which RO(s) amongst the ROs associated with the SSB the UE can use. ra-ssb-OccasionMaskIndex indicates whether the UE uses specific a RO, even RO, odd RO or all ROs. ra-ssb-OccasionMaskIndex is signaled in a CFRA configuration. ra-ssb-OccasionMaskIndex is also signaled in SI request resources. FIG. 5 below is an example of this approach.

FIG. 5 illustrates an example 500 of RACH Occasion masking according to embodiments of the present disclosure. The embodiment of RACH Occasion masking of FIG. 5 is for illustration only. Different embodiments of RACH Occasion masking could be used without departing from the scope of this disclosure.

In the example of FIG. 5, ROs of the same SSB are sequentially indexed. There are 4SSBs, and ra-ssb-OccasionMaskIndex is set to 2. During a random access procedure, the UE selects SSB 1. The UE is allowed to select the second RO of SSB 1 among all ROs associated with SSB 1.

Although FIG. 5 illustrates an example 500 of RACH Occasion masking, various changes may be made to FIG. 5. For example, various changes to the number of SSBs, the number of ROs, etc. could be made according to particular needs.

In case of Msg1 repetitions, ROs will be grouped per SSB where the size of an RO group depends on the number of Msg1 repetitions. There can be several RO groups associated with one SSB in an association period or period over which ROs are grouped and mapped to SSBs. It would be beneficial to assign different RO groups of SSBs to different UEs for contention free random access. The existing indexing approach cannot ensure that ROs assigned to a UE belong to the same RO group. The present disclosure provides enhancements that overcome these issues.

In one embodiment, a UE is camped to a cell. The UE receives/acquires/obtains system information block 1 (SIB1) from the cell, transmitted by a gNB of the cell. The SIB1 includes information regarding the availability and scheduling (e.g., mapping of SIBs to an SI message, periodicity, SI-window size) of other SIBs with an indication whether one or more SIBs/SI messages are only provided on-demand, and, in that case, the configuration needed by the UE to perform the SI request.

In some embodiments, the SIB1 may include zero, one or more of the following SI request configurations:
A first SI request configuration (e.g., si-RequestConfig) for transmitting an SI request on an initial uplink BWP (where the initial uplink BWP is configured by the IE initialUplinkBWP for a NUL in SIB1) of a normal uplink carrier (NUL). If the field rach-OccasionsSI is absent in this configuration, the UE uses the corresponding parameters configured in the RACH configuration (i.e., rach-ConfigCommon) of the initial uplink BWP of the NUL. There can be several instances of rach-ConfigCommon in the initial uplink BWP each associated with zero, one or more of the following features: small data transmissions, Msg3 repetitions, RedCap, slicing, and Msg1 repetitions. Here the instance of rach-ConfigCommon which is used for the SI request is the one which is not associated with any feature.
A 2^{nd} SI request configuration (e.g., si-RequestConfigSUL) for transmitting an SI request on an initial uplink BWP (where the initial uplink BWP is configured by the IE initialUplinkBWP for a SUL in SIB1) of a supplementary uplink carrier (SUL). If the field rach-OccasionsSI is absent in this configuration, the UE uses the corresponding parameters configured in the RACH configuration (i.e., rach-ConfigCommon) of the initial uplink BWP of the SUL. There can be several instances of rach-ConfigCommon in the initial uplink BWP each associated with zero, one or more of the following features: small data transmissions, Msg3 repetitions, RedCap, slicing, and Msg1 repetitions. Here the instance of rach-ConfigCommon which is used for the SI request is the one which is not associated with any feature.
A 3^{rd} SI request configuration (e.g., si-RequestConfigRedcap) for transmitting an SI request on a RedCap specific initial uplink BWP (where the RedCap specific initial uplink BWP is configured by the IE initiallplinkBWP-RedCap for a NUL in SIB1) of a normal uplink carrier (NUL). If the field rach-OccasionsSI is absent in this configuration, the UE uses the corresponding parameters configured in the RACH configuration (i.e., rach-ConfigCommon) of the RedCap specific initial uplink BWP of the NUL. There can be several instances of rach-ConfigCommon in the initial uplink BWP each associated with zero, one or more of the following features: small data transmissions, Msg3 repetitions, RedCap, slicing, and Msg1 repetitions. Here the instance of rach-ConfigCommon which is used for the SI request is the one which is not associated with any feature. Alternately, the instance of rach-ConfigCommon which is used for the SI request is the one which is associated with RedCap only.

Each of the above first, 2^{nd} and 3^{rd} SI request configuration may include:
rach-OccasionsSI: the configuration of dedicated RACH Occasions for SI. rach-OccasionsSI IE includes field rach-ConfigSI of type RACH-ConfigGeneric and ssb-perRACH-Occasion.si-RequestPeriod: the periodicity of the SI-Request configuration in number of association periods

si-RequestResources is the list of SI request resources. If there is only one entry in the list, the configuration is used for all SI messages for which broadcast status is set to notBroadcasting. Otherwise, the 1st entry in the list corresponds to the first SI message for which broadcast status is set to notBroadcasting, the 2^{nd} entry in the list corresponds to the second SI message for which broadcast status is set to notBroadcasting, and so on. The broadcast status for each SI message is indicated in SIB1.
Each SI request resource comprises:
   ra-PreambleStartIndex: if N SSBs are associated with a RACH occasion, where N>=1, for the i-th SSB (i=0, . . . , N−1) the preamble with preamble index=ra-PreambleStartIndex+i is used for the SI request; For N<1, the preamble with preamble index=ra-PreambleStartIndex is used for the SI request
   ra-AssociationPeriodIndex: the index of the association period in the si-RequestPeriod in which the UE can send the SI request for SI message(s) corresponding to this SI-RequestResources, using the preambles indicated by ra-PreambleStartIndex and rach occasions indicated by ra-ssb-OccasionMaskIndex. Association periods in si-RequestPeriod are indexed sequentially from 0.
   ra-ssb-OccasionMaskIndex: ROs associated with same SSB are sequentially indexed. ra-ssb-OccasionMaskIndex indicates which RO(s) amongst the ROs associated with an SSB the UE can use. ra-ssb-OccasionMaskIndex indicates whether the UE uses a specific RO, even RO, odd RO or all ROs.

In some embodiments, the SIB1 may include zero, one or more of the following SI request configurations:
A 4^{th} SI request configuration (e.g., si-RequestConfig8Repetitions) for transmitting the SI request with 8 repetitions on an initial uplink BWP (where the initial uplink BWP is configured by the IE initiallyplinkBWP for a NUL in SIB1) of a normal uplink carrier (NUL). If the field rach-OccasionsSI is absent in the configuration, the UE uses the corresponding parameters configured in the RACH configuration (i.e., rach-Config Common) of the NUL's initial uplink BWP where the RACH configuration is one for which there are 8 Msg1 repetitions.
A 5^{th} SI request configuration (e.g., si-RequestConfig4Repetitions) for transmitting the SI request with 4 repetitions on an initial uplink BWP (where the initial uplink BWP is configured by the IE initiallyplinkBWP for a NUL in SIB1) of a normal uplink carrier (NUL). If the field rach-OccasionsSI is absent in the configuration, the UE uses the corresponding parameters configured in the RACH configuration (i.e., rach-ConfigCommon) of the NUL's initial uplink BWP where the RACH configuration is one for which there are 4 Msg1 repetitions.
A 6^{th} SI request configuration (e.g., si-RequestConfig2Repetitions) for transmitting the SI request with 2 repetitions on an initial uplink BWP (where the initial uplink BWP is configured by the IE initiallyplinkBWP for a NUL in SIB1) of a normal uplink carrier (NUL). If the field rach-OccasionsSI is absent in the configuration, the UE uses the corresponding parameters configured in the RACH configuration (i.e., rach-Config Common) of the NUL's initial uplink BWP where the RACH configuration is one for which there are 2 Msg1 repetitions.
A 7^{th} SI request configuration (e.g., si-RequestConfigSUL8Repetitions) for transmitting the SI request with 8 repetitions on an initial uplink BWP (where the initial uplink BWP is configured by the IE initiallyplinkBWP for a SUL in SIB1) of a supplementary uplink carrier (SUL). If the field rach-OccasionsSI is absent in the configuration, the UE uses the corresponding parameters configured in the RACH configuration (i.e., rach-Config Common) of the SUL's initial uplink BWP where the RACH configuration is one for which there are 8 Msg1 repetitions.
An 8^{th} SI request configuration (e.g., si-RequestConfigSUL4Repetitions) for transmitting the SI request with 4 repetitions on an initial uplink BWP (where the initial uplink BWP is configured by the IE initiallyplinkBWP for a SUL in SIB1) of a supplementary uplink carrier (SUL). If the field rach-OccasionsSI is absent in the configuration, the UE uses the corresponding parameters configured in the RACH configuration (i.e., rach-Config Common) of the SUL's initial uplink BWP where the RACH configuration is one for which there are 4 Msg1 repetitions.
A 9^{th} SI request configuration (e.g., si-RequestConfigSUL2Repetitions) for transmitting the SI request with 2 repetitions on an initial uplink BWP (where the initial uplink BWP is configured by the IE initiallplinkBWP for a SUL in SIB1) of a supplementary uplink carrier (SUL). If the field rach-OccasionsSI is absent in the configuration, the UE uses the corresponding parameters configured in the RACH configuration (i.e., rach-Config Common) of the SUL's initial uplink BWP where the RACH configuration is one for which there are 2 Msg1 repetitions.
A 10^{th} SI request configuration (e.g., si-RequestConfigRedcap8Repetitions) for transmitting the SI request with 8 repetitions on a RedCap specific initial uplink BWP (where the RedCap specific initial uplink BWP is configured by the IE initiallJplinkBWP-RedCap for a NUL in SIB1) of a normal uplink carrier (NUL). If the field rach-OccasionsSI is absent in the configuration, the UE uses the corresponding parameters configured in the RACH configuration (i.e., rach-ConfigCommon) of the NUL's RedCap specific initial uplink BWP where the RACH configuration is one for which there are 8 Msg1 repetitions.
An 11^{th} SI request configuration (e.g., si-RequestConfigRedcap4Repetitions) for transmitting the SI request with 4 repetitions on a RedCap specific initial uplink BWP (where the RedCap specific initial uplink BWP is configured by the IE initiallJplinkBWP-RedCap for a NUL in SIB1) of a normal uplink carrier (NUL). If the field rach-OccasionsSI is absent in the configuration, the UE uses the corresponding parameters configured in the RACH configuration (i.e., rach-ConfigCommon) of the NUL's RedCap specific initial uplink BWP where the RACH configuration is one for which there are for 4 Msg1 repetitions.
A 12^{th} SI request configuration (e.g., si-RequestConfigRedcap2Repetitions) for transmitting the SI request with 2 repetitions on a RedCap specific initial uplink BWP (where the RedCap specific initial uplink BWP is configured by the IE initiallyplinkBWP-RedCap for a NUL in SIB1) of a normal uplink carrier (NUL). If the field rach-OccasionsSI is absent in the configuration, the UE uses the corresponding parameters configured in the RACH configuration (i.e., rach-ConfigCommon) of the NUL's RedCap specific initial uplink BWP where the RACH configuration is one for which there are 8 Msg1 repetitions.

In one embodiment, the 10^{th} SI request configuration may not be signaled, and the 4^{th} SI request configuration is applied for transmitting the SI request with 8 repetitions on the RedCap specific initial uplink BWP of the NUL.

In one embodiment, the 11^{th} SI request configuration may not be signaled, and the 5^{th} SI request configuration is applied for transmitting the SI request with 4 repetitions on the RedCap specific initial uplink BWP of the NUL.

In one embodiment, the 12^{th} SI request configuration may not be signaled, and the 6^{th} SI request configuration is applied for transmitting the SI request with 2 repetitions on the RedCap specific initial uplink BWP of the NUL.

In one embodiment, the 7^{th} SI request configuration may not be signaled, and the 4^{th} SI request configuration is applied for transmitting the SI request with 8 repetitions on the initial uplink BWP of the SUL.

In one embodiment, the 8^{th} SI request configuration may not be signaled, and the 5^{th} SI request configuration is applied for transmitting the SI request with 4 repetitions on the initial uplink BWP of the SUL.

In one embodiment, 9^{th} SI request configuration may not be signaled, and 6^{th} SI request configuration is applied for transmitting the SI request with 2 repetitions on an initial uplink BWP of SUL.

Each of the above 4^{th} to 12^{th} SI request configuration may include:
rach-OccasionsSI: the configuration of the dedicated RACH Occasions for the SI. rach-OccasionsSI IE includes field rach-ConfigSI of type RACH-ConfigGeneric and ssb-perRACH-Occasion.
si-RequestPeriod: the periodicity of the SI-Request configuration in the number of association periods (the period over which ROs are mapped SSBs at least once). In one embodiment the association period is the period over which RO groups are associated with all transmitted SSBs, and the group of ROs comprises N ROs where N (2/4/8) is the number of Msg1 repetitions.
si-RequestResources: the list of SI request resources. If there is only one entry in the list, the configuration is used for all SI messages for which the broadcast status is set to notBroadcasting. Otherwise, the 1st entry in the list corresponds to the first SI message for which broadcast status is set to notBroadcasting, the 2^{nd} entry in the list corresponds to the second SI message for which broadcast status is set to notBroadcasting and so on. The broadcast status for each SI message is indicated in SIB1.
Each SI request resource comprises:
   ra-PreambleStartIndex: If N SSBs are associated with a RACH occasion, where N>=1, for the i-th SSB (i=0, . . . , N−1) the preamble with preamble index=ra-PreambleStartIndex+i is used for the SI request. For N<1, the preamble with preamble index=ra-PreambleStartIndex is used for the SI request
   ra-AssociationPeriodIndex: The index of the association period in the si-RequestPeriod in which the UE can send the SI request for SI message(s) corresponding to this SI-RequestResources, using the preambles indicated by ra-PreambleStartIndex and rach occasions indicated by ra-ssb-OccasionGroupMaskIndex. Association periods in si-RequestPeriod are indexed sequentially from 0.
   ra-ssb-OccasionGroupMaskIndex: There can be several RO groups associated with one SSB in an association period or period over which ROs are grouped and mapped to SSBs. The RO groups associated with same SSB can be sequentially indexed. ra-ssb-OccasionGroupMaskIndex indicates which RO group(s) amongst the RO groups associated with SSB the UE can use. It indicates whether the UE uses a specific RO group, even RO group, odd RO group or all RO groups. FIG. 6 is one example of ra-ssb-OccasionGroupMaskIndex. There are two RO groups per SSB where each RO group comprises two ROs. FIG. 7 is another example of ra-ssb-OccasionGroupMaskIndex. ra-ssb-OccasionGroupMaskIndex can be set to zero to indicate that UE can use all RO groups. ra-ssb-OccasionGroupMaskIndex can be set to a pre-defined value (e.g., 8) to indicate that UE can use even RO groups. ra-ssb-OccasionGroupMaskIndex can be set to a pre-defined value (e.g., 9) to indicate that UE can use odd RO groups. ra-ssb-OccasionGroupMaskIndex can be set to a pre-defined value range (e.g., 1 to 7) to indicate that UE can use the RO group with index given ra-ssb-OccasionGroupMaskIndex.

FIG. 6 illustrates another example 600 of RACH Occasion masking according to embodiments of the present disclosure. The embodiment of RACH Occasion masking of FIG. 6 is for illustration only. Different embodiments of RACH Occasion masking could be used without departing from the scope of this disclosure.

In the example of FIG. 6, ROs of the same SSB are sequentially indexed. There are 4SSBs, ra-ssb-OccasionMaskIndex is set to 2, and the number of Msg1 repetitions is set to 2. During a random access procedure, the UE selects SSB 1. The UE is allowed to select the second RO group of SSB 1 among all RO groups associated with SSB 1.

Although FIG. 6 illustrates an example 600 of RACH Occasion masking, various changes may be made to FIG. 6. For example, various changes to the number of SSBs, the number of ROs, etc. could be made according to particular needs.

FIG. 7 illustrates another example 700 of RACH Occasion masking according to embodiments of the present disclosure. The embodiment of RACH Occasion masking of FIG. 7 is for illustration only. Different embodiments of RACH Occasion masking could be used without departing from the scope of this disclosure.

In the example of FIG. 7, ROs of the same SSB are sequentially indexed. There are 4SSBs, ra-ssb-OccasionMaskIndex is set to 2 and the number of Msg1 repetitions is set to 2. During a random access procedure, the UE selects SSB 1. The UE is allowed to select the second RO group of SSB 1 among all RO groups associated with SSB 1.

Although FIG. 7 illustrates an example 700 of RACH Occasion masking, various changes may be made to FIG. 7. For example, various changes to the number of SSBs, the number of ROs, etc. could be made according to particular needs.

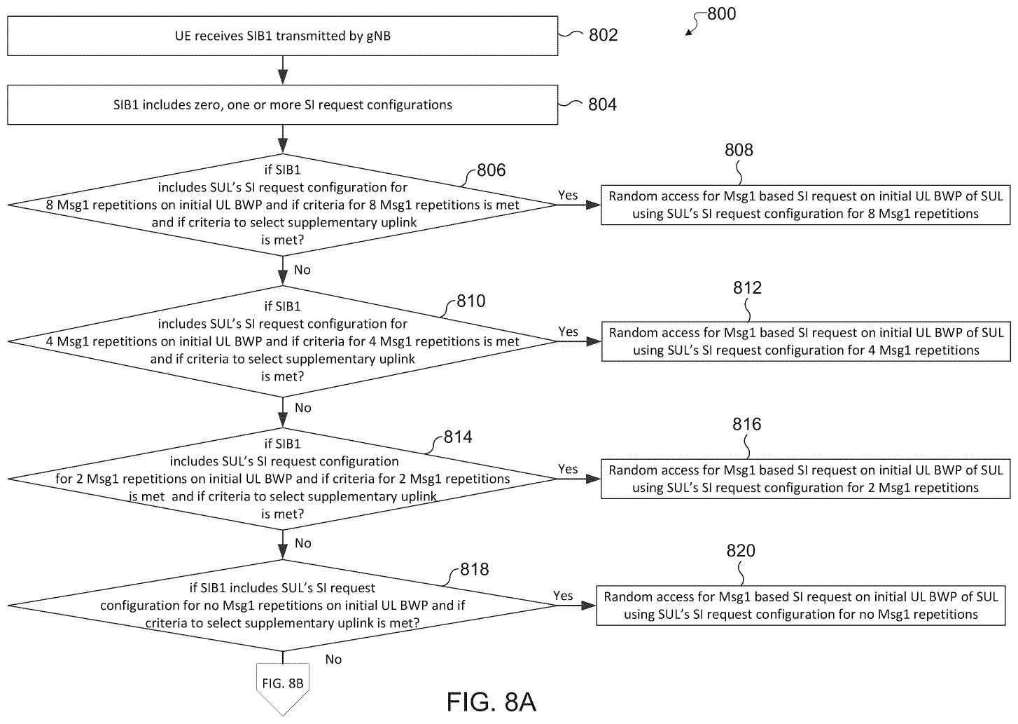

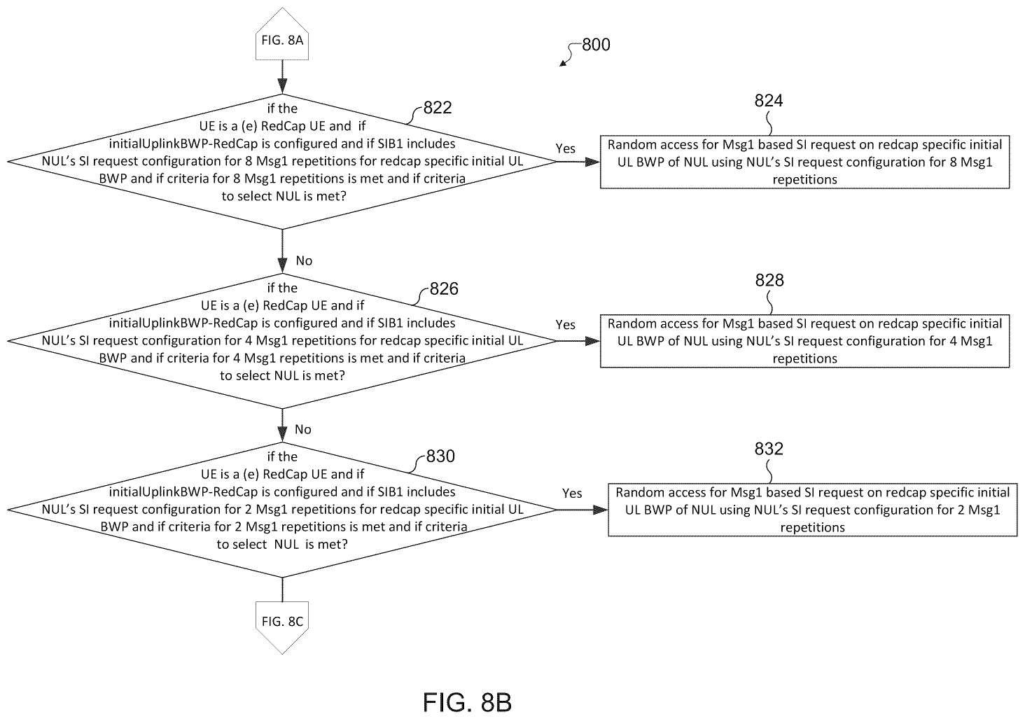

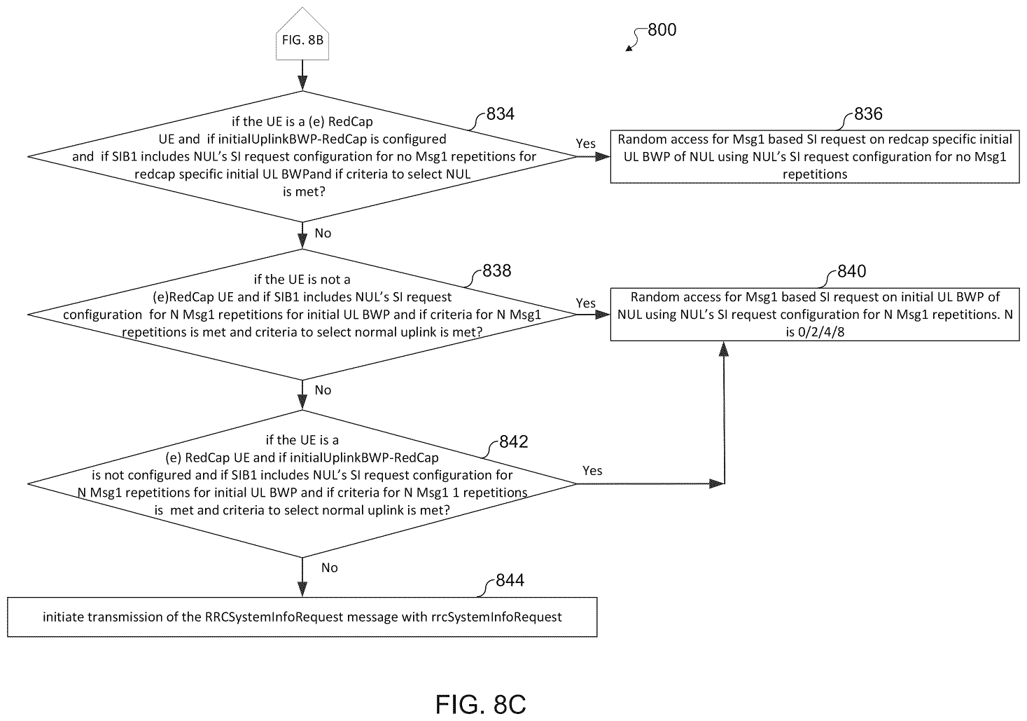

In one embodiment, the UE acquires one or more SI messages for which the broadcast status is set to not broadcasting. The UE determines whether to perform a Msg1 based SI request (i.e., a PRACH preamble transmitted by UE indicates the SI message(s) requested by the UE) or a Msg3 based SI request (i.e., a RRCSystemInformation request message is transmitted in a Msg3 where the message includes information about the SI messages/SIBs requested by the UE) as shown in FIGS. 8A-8C.

FIGS. 8A-8C illustrate a method 800 for requesting system information according to embodiments of the present disclosure. An embodiment of the method illustrated in FIGS. 8A-8C are for illustration only. One or more of the components illustrated in FIGS. 8A-8C may be implemented in specialized circuitry configured to perform the noted functions or one or more of the components may be implemented by one or more processors executing instructions to perform the noted functions. Other embodiments for requesting system information could be used without departing from the scope of this disclosure.

In the example of FIGS. 8A-8C, the method begins as step 802. At step 802, a UE such as UE 116 of FIG. 1 receives a SIB1 transmitted by a gNB, such as BS 103 of FIG. 1. At step 804, the SIB1 includes zero, one, or more SI request configurations.

At step 806, if the SIB1 includes si-SchedulingInfo containing si-RequestConfigSUL8Repetitions (or if the SIB1 includes the SUL's SI request configuration for 8 Msg1 repetitions or the 7^{th} SI request configuration) and if the criteria for 8 Msg1 repetitions is met and the criteria to select the supplementary uplink is met, the method proceeds to step 808. Otherwise, the method proceed to step 810.

At step 808, the UE triggers the lower layer (i.e., MAC) to initiate the random access procedure on the supplementary uplink using the PRACH preamble(s) and PRACH resource(s) in si-RequestConfigSUL8Repetitions (or in the SUL's SI request configuration for 8 Msg1 repetitions or the 7^{th} SI request configuration) corresponding to the SI message(s) that the UE uses to operate within the cell, and for which si-BroadcastStatus is set to notBroadcasting. During the random access procedure, the UE selects a SSB, and the UE selects a preamble corresponding to the selected SSB based on ra-PreambleStartIndex. The UE selects a set/group of 8 ROs. If ra-AssociationPeriodIndex and si-RequestPeriod are configured, the UE determines the next available set/group of 8 ROs from the set/group of 8 ROs corresponding to the selected SSB in the association period given by ra-AssociationPeriodIndex in the si-RequestPeriod permitted by the restrictions given by the ra-ssb-OccasionGroupMaskIndex if configured. Otherwise, the UE determines the next available set/group of 8 ROs from the set/group of 8 ROs corresponding to the selected SSB permitted by the restrictions given by the ra-ssb-OccasionGroupMaskIndex if configured. The UE transmits a Msg1 i.e., a random access preamble 8 times in the selected ROs. The UE monitors for an SI request ack after transmitting the Msg1 8 times. Random access parameters other than those configured in the SI request configuration are obtained from the RACH configuration (i.e., rach-ConfigCommon) of the SUL's initial uplink BWP where the RACH configuration is the one which is configured for 8 Msg1 repetitions. The preamble is transmitted on the SUL's initial uplink BWP. If acknowledgement for the SI request is received from the lower layers i.e., MAC (during the random access procedure initiated for SI request based on SI request configuration, acknowledgment for the SI request is a random access response, a MAC PDU for the random access response includes a MAC sub pdu with a header only where the header includes a RAPID of the transmitted preamble), the UE acquires the requested SI message(s) by monitoring the SI window(s) associated with the requested SI message(s) immediately.

At step 810, if the SIB1 includes si-SchedulingInfo containing si-RequestConfigSUL4Repetitions (or if the SIB1 includes the SUL's SI request configuration for 4 Msg1 repetitions or the 8^{th} SI request configuration) and if the criteria for 4 Msg1 repetitions is met and the criteria to select the supplementary uplink is met, the method proceeds to step 812. Otherwise, the method proceeds to step 814.

At step 812, the UE triggers the lower layer (i.e., MAC) to initiate the random access procedure on the supplementary uplink using the PRACH preamble(s) and PRACH resource(s) in si-RequestConfigSUL4Repetitions (or in the SUL's SI request configuration for 4Msg1 repetitions or the 8^{th} SI request configuration) corresponding to the SI message(s) that the UE uses to operate within the cell, and for which si-BroadcastStatus is set to notBroadcasting. During the random access procedure, the UE selects a SSB, and the UE selects a preamble corresponding to the selected SSB based on ra-PreambleStartIndex. The UE selects a set/group of 4 ROs. If ra-AssociationPeriodIndex and si-RequestPeriod are configured, the UE determines the next available set/group of 4 ROs from the set/group of 4 ROs corresponding to the selected SSB in the association period given by ra-AssociationPeriodIndex in the si-RequestPeriod permitted by the restrictions given by the ra-ssb-OccasionGroupMaskIndex if configured. Otherwise, the UE determines the next available set/group of 4 ROs from the set/group of 4 ROs corresponding to the selected SSB permitted by the restrictions given by the ra-ssb-OccasionGroupMaskIndex if configured. The UE transmits a Msg1 i.e., a random access preamble 4 times in the selected ROs. The UE monitors for an SI request ack after transmitting the Msg1 4 times. Random access parameters other than those configured in the SI request configuration are obtained from the RACH configuration (i.e., rach-ConfigCommon) of the SUL's initial uplink BWP where the RACH configuration is the one which is configured for 4 Msg1 repetitions. The preamble is transmitted on the SUL's initial uplink BWP. If acknowledgement for the SI request is received from the lower layers i.e., MAC (during the random access procedure initiated for the SI request based on the SI request configuration, acknowledgment for the SI request is a random access response, a MAC PDU for the random access response includes a MAC sub pdu with a header only where the header includes a RAPID of the transmitted preamble), the UE acquires the requested SI message(s) by monitoring the SI window(s) associated with the requested SI message(s) immediately.

At step 814, if the SIB1 includes si-SchedulingInfo containing si-RequestConfigSUL2Repetitions (or if the SIB1 includes the SUL's SI request configuration for 2 Msg1 repetitions or the 9^{th} SI request configuration) and if the criteria for 2 Msg1 repetitions is met and the criteria to select the supplementary uplink is met, the method proceeds to step 816. Otherwise, the method proceeds to step 818.

At step 816, the UE triggers the lower layer (i.e., MAC) to initiate the random access procedure on the supplementary uplink using the PRACH preamble(s) and PRACH resource(s) in si-RequestConfigSUL2Repetitions (or in the SUL's SI request configuration for 2 Msg1 repetitions or 9^{th} SI request configuration) corresponding to the SI message(s) that the UE uses to operate within the cell, and for which si-BroadcastStatus is set to notBroadcasting. During the random access procedure, the UE selects a SSB, and the UE selects a preamble corresponding to the selected SSB based on ra-PreambleStartIndex. The UE selects a set/group of 2 ROs. If ra-AssociationPeriodIndex and si-RequestPeriod are configured, the UE determines the next available set/group of 2 ROs from the set/group of 2 ROs corresponding to the selected SSB in the association period given by ra-AssociationPeriodIndex in the si-RequestPeriod permitted by the restrictions given by the ra-ssb-OccasionGroupMaskIndex if configured. Otherwise, the UE determines the next available set/group of 2 ROs from the set/group of 2 ROs corresponding to the selected SSB permitted by the restrictions given by the ra-ssb-OccasionGroupMaskIndex if configured. The UE transmits a Msg1 i.e., a random access preamble 2 times. The UE monitors for an SI request ack after transmitting the Msg1 2 times. Random access parameters other than those configured in the SI request configuration are obtained from the RACH configuration (i.e., rach-ConfigCommon) of the SUL's initial uplink BWP where the RACH configuration is the one which is for 2 Msg1 repetitions. The preamble is transmitted on the SUL's initial uplink BWP. If acknowledgement for the SI request is received from the lower layers i.e., MAC (during the random access procedure initiated for the SI request based on the SI request configuration, acknowledgment for the SI request is a random access response, a MAC PDU for the random access response includes a MAC sub pdu with a header only where the header includes a RAPID of the transmitted preamble), the UE acquires the requested SI message(s) by monitoring the SI window(s) associated with the requested SI message(s) immediately.

At step 818, if the SIB1 includes si-SchedulingInfo containing si-RequestConfigSUL (or if the SIB1 includes the SUL's SI request configuration for no repetitions or the 2^{nd} SI request configuration) and the criteria to select the supplementary uplink is met, the method proceeds to step 820. Otherwise, the method proceeds to step 822.

At step 820 the UE triggers the lower layer i.e., MAC to initiate the random access procedure on the supplementary uplink using the PRACH preamble(s) and PRACH resource(s) in si-RequestConfigSUL corresponding to the SI message(s) that the UE uses to operate within the cell, and for which si-BroadcastStatus is set to notBroadcasting. During the random access procedure, the UE selects a SSB, and the UE selects a preamble corresponding to the selected SSB based on ra-Preamble StartIndex. The UE selects a RO and transmits Msg1 i.e., a random access preamble. The UE monitors for an SI request ack after transmitting the Msg1. Random access parameters other than those configured in the SI request configuration are obtained from the RACH configuration (i.e., rach-ConfigCommon) of the SUL's initial uplink BWP where the RACH configuration is the one which is not associated with any feature. The preamble is transmitted on the SUL's initial uplink BWP. If acknowledgement for the SI request is received from the lower layers i.e., MAC (during the random access procedure initiated for the SI request based on the SI request configuration, acknowledgment for the SI request is a random access response, a MAC PDU for the random access response includes a MAC sub pdu with a header only where the header includes a RAPID of the transmitted preamble), the UE acquires the requested SI message(s) by monitoring the SI window(s) associated with the requested SI message(s) immediately.

At step 822, if the UE is a (e) RedCap UE and if initialllplinkBWP-RedCap is configured and if the SIB1 includes si-SchedulingInfo containing si-RequestConfigRedCap8Repetitions (or if the SIB1 includes the NUL's SI request configuration for 8 Msg1 repetitions for the RedCap specific initial UL BWP or the 10^{th} SI request configuration) and if the criteria for 8 Msg1 repetitions is met and the criteria to select the normal uplink is met, the method proceeds to step 824. Otherwise, the method proceeds to step 826.

At step 824, the UE triggers the lower layer to initiate the random access procedure on the normal uplink using the PRACH preamble(s) and PRACH resource(s) in si-RequestConfigRedCap8Repetitions corresponding to the SI message(s) that the UE uses to operate within the cell, and for which si-BroadcastStatus is set to notBroadcasting. During the random access procedure, the UE selects a SSB, and the UE selects a preamble corresponding to the selected SSB based on ra-PreambleStartIndex. The UE selects a set/group of 8 ROs. If ra-AssociationPeriodIndex and si-RequestPeriod are configured, the UE determines the next available set/group of 8 ROs from the set/group of 8 ROs corresponding to the selected SSB in the association period given by ra-AssociationPeriodIndex in the si-RequestPeriod permitted by the restrictions given by the ra-ssb-OccasionGroupMaskIndex if configured. Otherwise, the UE determines the next available set/group of 8 ROs from the set/group of 8 ROs corresponding to the selected SSB permitted by the restrictions given by the ra-ssb-OccasionGroupMaskIndex if configured. The UE transmits a Msg1 i.e., a random access preamble 8 times. The UE monitors for an SI request ack after transmitting the Msg1 8 times. Random access parameters other than those configured in the SI request configuration are obtained from the RACH configuration (i.e., rach-ConfigCommon) of the NUL's RedCap specific initial uplink BWP where the RACH configuration is the one which is for 8 Msg1 repetitions. The preamble is transmitted on the NUL's RedCap specific initial uplink BWP. If acknowledgement for the SI request is received from the lower layers i.e., MAC (during the random access procedure initiated for the SI request based on the SI request configuration, acknowledgment for the SI request is a random access response, a MAC PDU for the random access response includes a MAC sub pdu with a header only where the header includes a RAPID of the transmitted preamble), the UE acquires the requested SI message(s) by monitoring the SI window(s) associated with the requested SI message(s) immediately.

At step 826 if the UE is a (e) RedCap UE and if initiallyplinkBWP-RedCap is configured and if the SIB1 includes si-SchedulingInfo containing si-RequestConfigRedCap4Repetitions (or if the SIB1 includes the NUL's SI request configuration for 4 repetitions for the RedCap specific initial UL BWP or the 11^{th} SI request configuration) and if the criteria for 4 Msg1 repetitions is met and the criteria to select the normal uplink is met, the method proceeds to step 828. Otherwise, the method proceeds to step 830.

At step 828 the UE triggers the lower layer to initiate the random access procedure on the normal uplink using the PRACH preamble(s) and PRACH resource(s) in si-RequestConfigRedCap4Repetitions corresponding to the SI message(s) that the UE uses to operate within the cell, and for which si-BroadcastStatus is set to notBroadcasting; During the random access procedure, the UE selects a SSB, and the UE selects a preamble corresponding to the selected SSB based on ra-PreambleStartIndex. The UE selects a set/group of 4 ROs. If ra-AssociationPeriodIndex and si-RequestPeriod are configured, the UE determines the next available set/group of 4 ROs from the set/group of 4 ROs corresponding to the selected SSB in the association period given by ra-AssociationPeriodIndex in the si-RequestPeriod permitted by the restrictions given by the ra-ssb-OccasionGroupMaskIndex if configured. Otherwise, the UE determines the next available set/group of 4 ROs from the set/group of 4 ROs corresponding to the selected SSB permitted by the restrictions given by the ra-ssb-OccasionGroupMaskIndex if configured. The UE transmits a Msg1 i.e., a random access preamble 4 times. The UE monitors for an SI request ack after transmitting the Msg1 4 times. Random access parameters other than those configured in the SI request configuration are obtained from the RACH configuration (i.e., rach-ConfigCommon) of the NUL's RedCap specific initial uplink BWP where the RACH configuration is the one which is for 4 Msg1 repetitions. The preamble is transmitted on the NUL's RedCap specific initial uplink BWP. If acknowledgement for the SI request is received from the lower layers i.e., MAC (during the random access procedure initiated for the SI request based on the SI request configuration, acknowledgment for the SI request is a random access response, a MAC PDU for the random access response includes a MAC sub pdu with a header only where the header includes a RAPID of the transmitted preamble), the UE acquires the requested SI message(s) by monitoring the SI window(s) associated with the requested SI message(s) immediately.

At step 830, if the UE is a (e) RedCap UE and if initiallJplinkBWP-RedCap is configured and if the SIB1 includes si-SchedulingInfo containing si-RequestConfigRedCap2Repetitions (or if the SIB1 includes the NUL's SI request configuration for 2 Msg1 repetitions for the RedCap specific initial UL BWP or 12^{th} SI request configuration) and if the criteria for two Msg1 repetitions is met and the criteria to select the normal uplink is met, the method proceeds to step 832. Otherwise, the method proceeds to step 834.

At step 832 the UE triggers the lower layer to initiate the random access procedure on the normal uplink using the PRACH preamble(s) and PRACH resource(s) in si-RequestConfigRedCap2Repetitions corresponding to the SI message(s) that the UE uses to operate within the cell, and for which si-BroadcastStatus is set to notBroadcasting. During the random access procedure, the UE selects a SSB, and the UE selects a preamble corresponding to the selected SSB based on ra-PreambleStartIndex. The UE selects a set/group of 2 ROs. If ra-AssociationPeriodIndex and si-RequestPeriod are configured, the UE determines the next available set/group of 2 ROs from the set/group of 2 ROs corresponding to the selected SSB in the association period given by ra-AssociationPeriodIndex in the si-RequestPeriod permitted by the restrictions given by the ra-ssb-OccasionGroupMaskIndex if configured. Otherwise, the UE determines the next available set/group of 2 ROs from the set/group of 2 ROs corresponding to the selected SSB permitted by the restrictions given by the ra-ssb-OccasionGroupMaskIndex if configured. The UE transmits a Msg1 i.e., a random access preamble 2 times. The UE monitors for an SI request ack after transmitting the Msg1 2 times. Random access parameters other than those configured in the SI request configuration are obtained from the RACH configuration (i.e., rach-ConfigCommon) of the NUL's RedCap specific initial uplink BWP where the RACH configuration is the one which is for 2 Msg1 repetitions. The preamble is transmitted on the NUL's RedCap specific initial uplink BWP. If acknowledgement for the SI request is received from the lower layers i.e., MAC (during the random access procedure initiated for the SI request based on the SI request configuration, acknowledgment for the SI request is a random access response, a MAC PDU for the random access response includes a MAC sub pdu with a header only where the header includes a RAPID of the transmitted preamble) the UE acquires the requested SI message(s) by monitoring the SI window(s) associated with the requested SI message(s) immediately.

At step 834, if the UE is a RedCap UE and if initiallJplinkBWP-RedCap is configured and if the SIB1 includes si-SchedulingInfo containing si-RequestConfigRedCap (or if the SIB1 includes the NUL's SI request configuration for no Msg1 repetitions for the RedCap specific initial UL BWP or the 3^{rd} SI request configuration) and the criteria to select the normal uplink is met, the method proceeds to step 836. Otherwise, the method proceeds to step 838.

At step 836, the UE triggers the lower layer to initiate the random access procedure on the normal uplink using the PRACH preamble(s) and PRACH resource(s) in si-RequestConfigRedcap corresponding to the SI message(s) that the UE uses to operate within the cell, and for which si-BroadcastStatus is set to notBroadcasting. During the random access procedure, the UE selects a SSB, and the UE selects a preamble corresponding to the selected SSB based on ra-Preamble StartIndex. The UE selects a RO and transmits a Msg1 i.e., a random access preamble. If ra-AssociationPeriodIndex and si-RequestPeriod are configured, the UE determines the next available RO from the ROs corresponding to the selected SSB in the association period given by ra-AssociationPeriodIndex in the si-RequestPeriod permitted by the restrictions given by the ra-ssb-OccasionMaskIndex if configured. Otherwise, the UE determines the next available RO from the ROs corresponding to the selected SSB permitted by the restrictions given by the ra-ssb-OccasionMaskIndex if configured. The UE monitors for an SI request ack after transmitting the Msg1. Random access parameters other than those configured in the SI request configuration are obtained from the RACH configuration (i.e., rach-ConfigCommon) of the NUL's RedCap specific initial uplink BWP where the RACH configuration is the one which is not associated with any feature. The preamble is transmitted on the NUL's RedCap specific initial uplink BWP. If acknowledgement for the SI request is received from the lower layers i.e., MAC (during the random access procedure initiated for the SI request based on the SI request configuration, acknowledgment for the SI request is a random access response, a MAC PDU for the random access response includes a MAC sub pdu with a header only where the header includes a RAPID of the transmitted preamble) the UE acquires the requested SI message(s) by monitoring the SI window(s) associated with the requested SI message(s) immediately.

At step 838, if the UE is not a (e) RedCap UE and if the SIB1 includes the NUL's SI request configuration for N (N equals 8 or 4 or 2 or 0) Msg1 repetitions for initial UL BWP and if the criteria for N Msg1 repetitions is met and the criteria to select the normal uplink is met the method proceeds to step 840. Otherwise, the method proceeds to step 842.

At step 842, if the UE is a (e) RedCap UE and if initiallyplinkBWP-RedCap is not configured and if the SIB1 includes the NUL's SI request configuration for N (N equals 8 or 4 or 2 or 0) Msg1 repetitions for initial UL BWP or 4^{th} SI request configuration) and if the criteria for N Msg1 repetitions is met and the criteria to select the normal uplink is met; the method proceeds to step 840. Otherwise, the method proceeds to step 844.

At step 840, the UE triggers the lower layer (i.e., MAC) to initiate the random access procedure on the normal uplink using the PRACH preamble(s) and PRACH resource(s) in in NUL's SI request configuration for N Msg1 repetitions corresponding to the SI message(s) that the UE uses to operate within the cell, and for which si-BroadcastStatus is set to notBroadcasting. During the random access procedure, the UE selects a SSB, and the UE selects a preamble corresponding to the selected SSB based on ra-Preamble StartIndex. The UE selects a set/group of N ROs. If ra-AssociationPeriodIndex and si-RequestPeriod are configured, the UE determines the next available set/group of N ROs from the set/group of N ROs corresponding to the selected SSB in the association period given by ra-AssociationPeriodIndex in the si-RequestPeriod permitted by the restrictions given by the ra-ssb-OccasionGroupMaskIndex if configured. Otherwise, the UE determines the next available set/group of N ROs from the set/group of N ROs corresponding to the selected SSB permitted by the restrictions given by the ra-ssb-OccasionGroupMaskIndex if configured. The UE transmits a Msg1 i.e., a random access preamble N times. The UE monitors for an SI request ack after transmitting the Msg1 N times. Random access parameters other than those configured in the SI request configuration are obtained from the RACH configuration (i.e., rach-ConfigCommon) of the NUL's initial uplink BWP where the RACH configuration is the one which is for N Msg1 repetitions. Preamble is transmitted on NUL's initial uplink BWP. If acknowledgement for the SI request is received from the lower layers i.e., MAC (during the random access procedure initiated for the SI request based on the SI request configuration, acknowledgment for the SI request is a random access response, a MAC PDU for the random access response includes a MAC sub pdu with a header only where the header includes a RAPID of the transmitted preamble) the UE acquires the requested SI message(s) by monitoring the SI window(s) associated with the requested SI message(s) immediately.

At step 844, the UE applies the default L1 parameter values as specified in the corresponding physical layer specifications except for the parameters for which values are provided in the SIB1. The UE applies the default MAC Cell Group configuration. The UE applies the time Alignment TimerCommon included in the SIB1. The UE applies the CCCH configuration. The UE initiates transmission of the RRC SystemInfoRequest message with rrcSystemInfoRequest. If acknowledgement for RRCSystemInfoRequest message with rrcSystemInfoRequest is received from lower layers, the UE acquires the requested SI message(s), immediately.

Although FIGS. 8A-8C illustrate one example of a method 800 for requesting system information, various changes may be made to FIGS. 8A-8C. For example, while shown as a series of steps, various steps in FIGS. 8A-8C could overlap, occur in parallel, occur in a different order, occur any number of times, be omitted, or replaced by other steps.

In one embodiment, If the set of random-access resources for 8 Msg1 repetitions is configured in the BWP and if the RSRP of the downlink pathloss reference <rsrp-ThresholdPRACHRepetitons for 8 Msg1 repetitions; or if the BWP is configured only withthe set of random-access resources for 8 Msg1 repetitions, the criteria for 8 Msg1 repetitions is met.

Otherwise, if the set of random-access resources for 4 Msg1 repetitions is configured in the BWP and if the RSRP of the downlink pathloss reference <rsrp-ThresholdPRACHRepetitons for 4 Msg1 repetitions; or if the BWP is configured only with set of random-access resources for 4 Msg1 repetitions, the criteria for 4 Msg1 repetitions is met.

Otherwise, if the set of random-access resources for 2 Msg1 repetitions is configured in the BWP and if the RSRP of the downlink pathloss reference <rsrp-ThresholdPRACHRepetitons for 2 Msg1 repetitions; or if the BWP is configured only with set of random-access resources for 2 Msg1 repetitions the criteria for 2 Msg1 repetitions is met.

Otherwise, the criterion for no repetitions is met.

In one embodiment, rsrp-ThresholdPRACHRepetitons for 2/4/8 Msg1 repetitions are received by UE from the gNB (e.g., in system information such as SIB1).

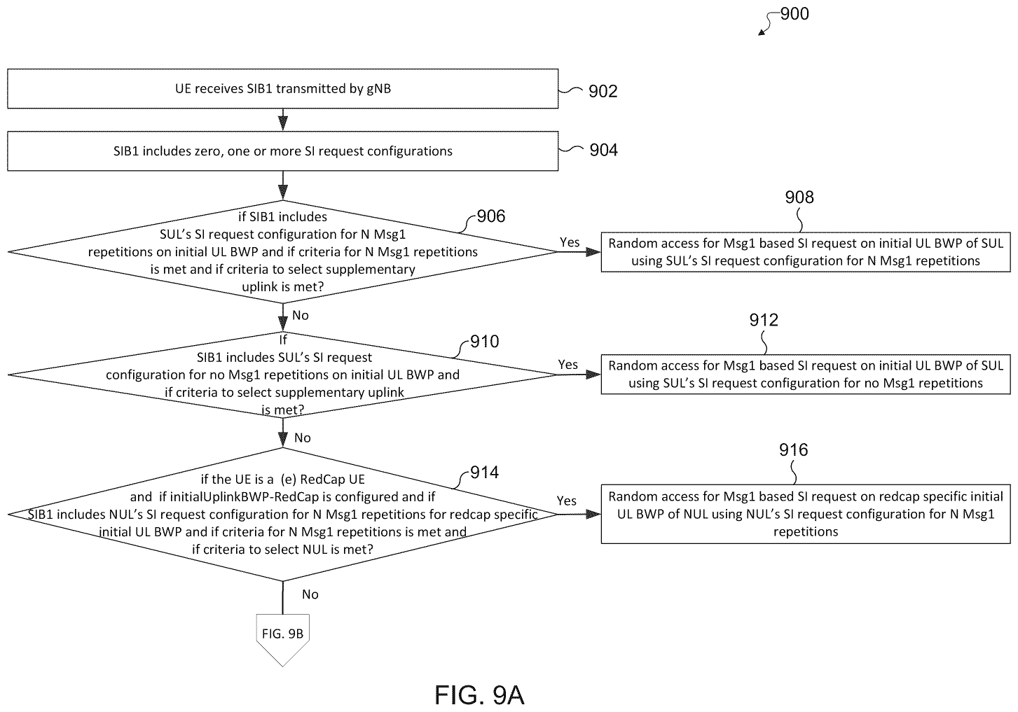

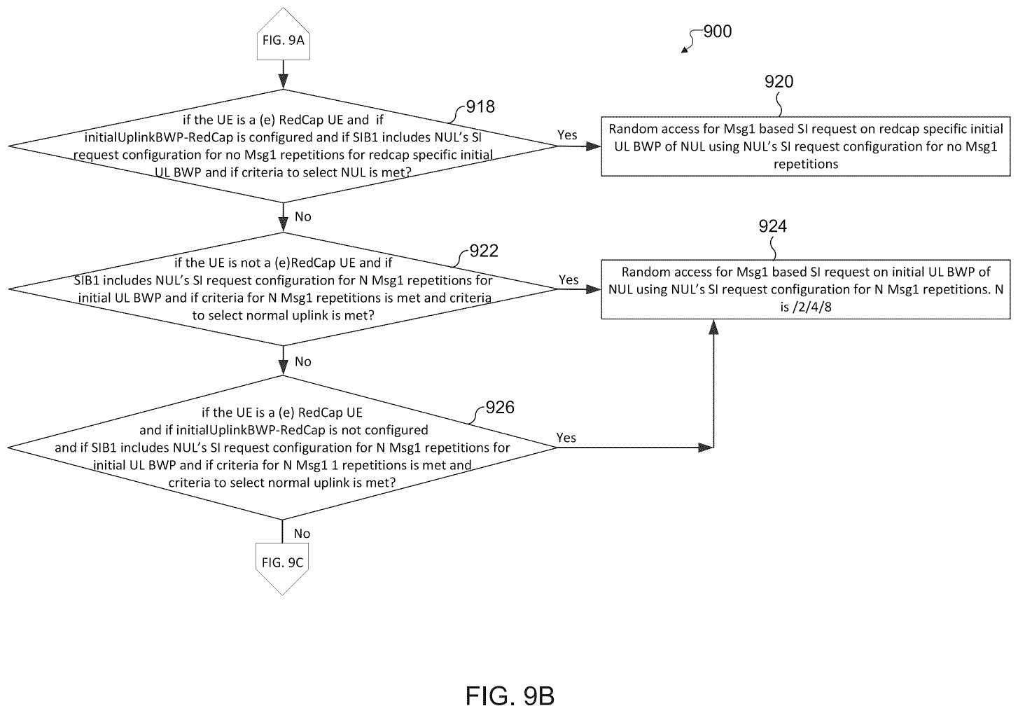

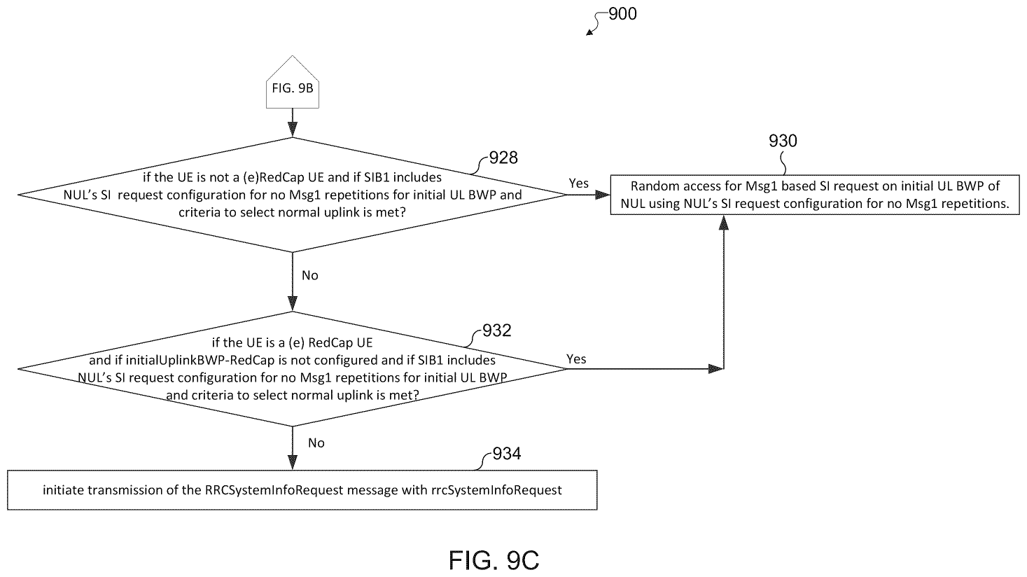

In one embodiment, if a cell is configured with a supplementary uplink and if the RSRP of the downlink pathloss reference is less than rsrp-ThresholdSSB-SUL, the UE selects the SUL carrier for performing random access procedure. Otherwise, the UE selects the NUL carrier for performing random access procedure. The UE acquires one or more SI messages for which broadcast status is set to not broadcasting. The UE determines whether to perform a Msg1 based SI request (i.e., PRACH preamble transmitted by UE indicates the SI message(s) requested by UE) or Msg3 based SI request (RRCSystemInformation request message is transmitted in Msg3 where the message includes information about the SI messages/SIBs requested by the UE) as shown in FIGS. 9A-9C.

FIGS. 9A-9C illustrate a method 900 for requesting system information according to embodiments of the present disclosure. An embodiment of the method illustrated in FIGS. 9A-9C are for illustration only. One or more of the components illustrated in FIGS. 9A-9C may be implemented in specialized circuitry configured to perform the noted functions or one or more of the components may be implemented by one or more processors executing instructions to perform the noted functions. Other embodiments for requesting system information could be used without departing from the scope of this disclosure.

In the example of FIGS. 9A-9C, the method begins as step 902. At step 902, a UE such as UE 116 of FIG. 1 receives a SIB1 transmitted by a gNB, such as BS 103 of FIG. 1. At step 904, the SIB1 includes zero, one, or more SI request configurations.

At step 906, if the criteria for N (N equals 2 or 4 or 8) message 1 repetitions is met and if the SIB1 includes the SUL's SI request configuration for N Msg1 repetitions for initial UL BWP and the criteria to select the supplementary uplink is met, the method proceeds to step 908. Otherwise, the method proceeds to step 910.

At step 908, the UE triggers the lower layer (i.e., MAC) to initiate the random access procedure on the supplementary uplink using the PRACH preamble(s) and PRACH resource(s) in SUL's SI request configuration for the N Msg1 repetitions corresponding to the SI message(s) that the UE uses to operate within the cell, and for which si-BroadcastStatus is set to notBroadcasting; During the random access procedure, the UE selects a SSB, and the UE selects a preamble corresponding to the selected SSB based on ra-Preamble StartIndex. The UE selects a set/group of N ROs and transmits a Msg1 i.e., a random access preamble N times. If ra-AssociationPeriodIndex and si-RequestPeriod are configured, the UE determines the next available set/group of N ROs from the set/group of N ROs corresponding to the selected SSB in the association period given by ra-AssociationPeriodIndex in the si-RequestPeriod permitted by the restrictions given by the ra-ssb-OccasionGroupMaskIndex if configured. Otherwise, the UE determines the next available set/group of N ROs from the set/group of N ROs corresponding to the selected SSB permitted by the restrictions given by the ra-ssb-OccasionGroupMaskIndex if configured. The UE monitors for an SI request ack after transmitting the Msg1 N times. Random access parameters other than those configured in the SI request configuration are obtained from the RACH configuration (i.e., rach-ConfigCommon) of the SUL's initial uplink BWP where the RACH configuration is the one which is for N Msg1 repetitions. The preamble is transmitted on the SUL's initial uplink BWP. If acknowledgement for the SI request is received from the lower layers i.e., MAC (during the random access procedure initiated for the SI request based on the SI request configuration, acknowledgment for the SI request is a random access response, a MAC PDU for the random access response includes a MAC sub pdu with a header only where the header includes a RAPID of the transmitted preamble), the UE acquires the requested SI message(s) by monitoring the SI window(s) associated with the requested SI message(s) immediately.

At step 910, if the SIB1 includes si-SchedulingInfo containing si-RequestConfigSUL (or the SIB1 includes the SUL's SI request configuration for no repetitions for initial UL BWP or the 2^{nd} SI request configuration) and the criteria to select the supplementary uplink is met, the method proceeds to step 912. Otherwise, the method proceeds to step 914.

At step 912, the UE triggers the lower layer i.e., MAC to initiate the random access procedure on the supplementary uplink using the PRACH preamble(s) and PRACH resource(s) in si-RequestConfigSUL corresponding to the SI message(s) that the UE uses to operate within the cell, and for which si-BroadcastStatus is set to notBroadcasting. During the random access procedure, the UE selects a SSB, and the UE selects a preamble corresponding to the selected SSB based on ra-Preamble StartIndex. The UE selects a RO and transmits a Msg1 i.e., a random access preamble. The UE monitors for an SI request ack after transmitting the Msg1. Random access parameters other than those configured in the SI request configuration are obtained from the RACH configuration (i.e., rach-ConfigCommon) of the SUL's initial uplink BWP where the RACH configuration is the one which is not associated with any feature. The preamble is transmitted on the SUL's initial uplink BWP. If acknowledgement for the SI request is received from the lower layers i.e., MAC (during the random access procedure initiated for the SI request based on the SI request configuration, acknowledgment for the SI request is a random access response, a MAC PDU for the random access response includes a MAC sub pdu with a header only where the header includes a RAPID of the transmitted preamble), the UE acquires the requested SI message(s) by monitoring the SI window(s) associated with the requested SI message(s) immediately.

At step 914, if the UE is a (e) RedCap UE and if initiallplinkBWP-RedCap is configured and if the criteria for N (N equals 2 or 4 or 8) message 1 repetitions is met and if the SIB1 includes the NUL's SI request configuration for N repetitions for the RedCap specific initial UL BWP and the criteria to select the normal uplink is met, the method proceeds to step 916. Otherwise, the method proceeds to step 918.

At step 916, the UE triggers the lower layer to initiate the random access procedure on the normal uplink using the PRACH preamble(s) and PRACH resource(s) in NUL's SI request configuration for the N repetitions for the RedCap specific initial UL BWP corresponding to the SI message(s) that the UE uses to operate within the cell, and for which si-BroadcastStatus is set to notBroadcasting. During the random access procedure, the UE selects a SSB, and the UE selects a preamble corresponding to the selected SSB based on ra-PreambleStartIndex. The UE selects a set/group of N ROs and transmits a Msg1 i.e., a random access preamble N times. If ra-AssociationPeriodIndex and si-RequestPeriod are configured, the UE determines the next available set/group of N ROs from the set/group of N ROs corresponding to the selected SSB in the association period given by ra-AssociationPeriodIndex in the si-RequestPeriod permitted by the restrictions given by the ra-ssb-OccasionGroupMaskIndex if configured. Otherwise, the UE determines the next available set/group of N ROs from the set/group of N ROs corresponding to the selected SSB permitted by the restrictions given by the ra-ssb-OccasionGroupMaskIndex if configured. The UE monitors for an SI request ack after transmitting the Msg1 N times. Random access parameters other than those configured in the SI request configuration are obtained from the RACH configuration (i.e., rach-ConfigCommon) of the NUL's RedCap specific initial uplink BWP where the RACH configuration is the one which is for N Msg1 repetitions. The preamble is transmitted on the NUL's RedCap specific initial uplink BWP. If acknowledgement for the SI request is received from the lower layers i.e., MAC (during the random access procedure initiated for the SI request based on the SI request configuration, acknowledgment for the SI request is a random access response, a MAC PDU for the random access response includes a MAC sub pdu with a header only where the header includes a RAPID of the transmitted preamble) the UE acquires the requested SI message(s) by monitoring the SI window(s) associated with the requested SI message(s) immediately.

At step 918, if the UE is a RedCap UE and if initiallJplinkBWP-RedCap is configured and if the SIB1 includes si-SchedulingInfo containing si-RequestConfigRedCap (or the SIB1 includes the NUL's SI request configuration for no Msg1 repetitions or 3^{rd} SI request configuration) and the criteria to select the normal uplink is met, the method proceeds to step 920. Otherwise, the method proceeds to step 922.

At step 920, the UE triggers the lower layer to initiate the random access procedure on the normal uplink using the PRACH preamble(s) and PRACH resource(s) in si-RequestConfigRedcap corresponding to the SI message(s) that the UE uses to operate within the cell, and for which si-BroadcastStatus is set to notBroadcasting. During the random access procedure, the UE selects a SSB, and the UE selects a preamble corresponding to the selected SSB based on ra-Preamble StartIndex. The UE selects a RO and transmits a Msg1 i.e., a random access preamble. The UE monitors for an SI request ack after transmitting the Msg1. Random access parameters other than those configured in the SI request configuration are obtained from the RACH configuration (i.e., rach-ConfigCommon) of the NUL's RedCap specific initial uplink BWP where the RACH configuration is the one which is not associated with any feature. The preamble is transmitted on the NUL's RedCap specific initial uplink BWP. If acknowledgement for the SI request is received from the lower layers i.e., MAC (during the random access procedure initiated for the SI request based on the SI request configuration, acknowledgment for the SI request is a random access response, a MAC PDU for the random access response includes a MAC sub pdu with a header only where the header includes a RAPID of the transmitted preamble) the UE acquires the requested SI message(s) by monitoring the SI window(s) associated with the requested SI message(s) immediately.

At step 922, if the UE is not a (e) RedCap UE and if the criteria for N (N equals 2 or 4 or 8) message 1 repetitions is met and if the SIB1 includes si-SchedulingInfo containing NUL's SI request configuration for N Msg1 repetitions and the criteria to select the normal uplink, the method proceeds to step 924. Otherwise, the method proceeds to step 926.

At step 926, if the UE is a (e) RedCap UE and if initiall/plinkBWP-RedCap is not configured and if the criteria for N (N equals 2 or 4 or 8) message 1 repetitions is met and if the SIB1 includes the NUL's SI request configuration for N Msg1 repetitions and the criteria to select the normal uplink is met, the method proceeds to step 914. Otherwise, the method proceeds to step 928.

At step 924, the UE triggers the lower layer (i.e., MAC) to initiate the random access procedure on the normal uplink using the PRACH preamble(s) and PRACH resource(s) in NUL's SI request configuration for the N Msg1 repetitions corresponding to the SI message(s) that the UE uses to operate within the cell, and for which si-BroadcastStatus is set to notBroadcasting; During the random access procedure, the UE selects a SSB, and the UE selects a preamble corresponding to the selected SSB based on ra-Preamble StartIndex. The UE selects a set/group of N ROs and transmits a Msg1 i.e., a random access preamble N times. The UE monitors for an SI request ack after transmitting the Msg1 N times. Random access parameters other than those configured in the SI request configuration are obtained from the RACH configuration (i.e., rach-Config Common) of the NUL's initial uplink BWP where the RACH configuration is the one which is for N Msg1 repetitions. Preamble is transmitted on NUL's initial uplink BWP. If acknowledgement for the SI request is received from the lower layers i.e., MAC (during the random access procedure initiated for the SI request based on the SI request configuration, acknowledgment for the SI request is a random access response, a MAC PDU for the random access response includes a MAC sub pdu with a header only where the header includes a RAPID of the transmitted preamble) the UE acquires the requested SI message(s) by monitoring the SI window(s) associated with the requested SI message(s) immediately.

At step 928, if the UE is not a RedCap UE and if the SIB1 includes si-SchedulingInfo containing si-RequestConfig (or the SIB1 includes the NUL's SI request configuration for no repetitions or 1^{st} SI request configuration) and the criteria to select the normal uplink is met, the method proceed to step 930. Otherwise, the method proceeds to step 932.

At step 932, if the UE is a RedCap UE and if initiallyplinkBWP-RedCap is not configured and if the SIB1 includes si-SchedulingInfo containing si-RequestConfig (or the SIB1 includes the NUL's SI request configuration for no repetitions or 1^{st} SI request configuration) and the criteria to select the normal uplink is met, the method proceed to step 930. Otherwise, the method proceeds to step 934.

At step 930, the UE triggers the lower layer i.e., MAC to initiate the random access procedure on the supplementary uplink using the PRACH preamble(s) and PRACH resource(s) in si-RequestConfig corresponding to the SI message(s) that the UE uses to operate within the cell, and for which si-BroadcastStatus is set to notBroadcasting. During the random access procedure, the UE selects a SSB, and the UE selects a preamble corresponding to the selected SSB based on ra-Preamble StartIndex. The UE selects a RO and transmits a Msg1 i.e., a random access preamble. The UE monitors for an SI request ack after transmitting the Msg1. Random access parameters other than those configured in the SI request configuration are obtained from the RACH configuration (i.e., rach-ConfigCommon) of the NUL's initial uplink BWP where the RACH configuration is the one which is not associated with any feature. Preamble is transmitted on NUL's initial uplink BWP. If acknowledgement for the SI request is received from the lower layers i.e., MAC (during the random access procedure initiated for the SI request based on the SI request configuration, acknowledgment for the SI request is a random access response, a MAC PDU for the random access response includes a MAC sub pdu with a header only where the header includes a RAPID of the transmitted preamble), the UE acquires the requested SI message(s) by monitoring the SI window(s) associated with the requested SI message(s) immediately.

At step 934, the UE applies the default L1 parameter values as specified in the corresponding physical layer specifications except for the parameters for which values are provided in the SIB1. The UE applies the default MAC Cell Group configuration. The UE applies the time AlignmentTimerCommon included in the SIB1. The UE applies the CCCH configuration. The UE initiates transmission of the RRC SystemInfoRequest message with rrcSystemInfoRequest. If acknowledgement for the RRCSystemInfoRequest message with rrcSystemInfoRequest is received from lower layers, the UE acquires the requested SI message(s), immediately.

Although FIGS. 9A-9C illustrate one example of a method 900 for requesting system information, various changes may be made to FIGS. 9A-9C. For example, while shown as a series of steps, various steps in FIGS. 9A-9C could overlap, occur in parallel, occur in a different order, occur any number of times, be omitted, or replaced by other steps.

In one embodiment, a UE is camped to a cell. The UE receives/acquires/obtains system information block 1 (SIB1) from the cell, transmitted by a gNB of the cell. The SIB1 includes information regarding the availability and scheduling (e.g., mapping of SIBs to SI message, periodicity, SI-window size) of other SIBs with an indication whether one or more SIBs/SI messages are only provided on-demand, and, in that case, the configuration needed by the UE to perform the SI request.

The SIB1 may include zero, one or more of the following SI request configurations:
A first SI request configuration (e.g., si-RequestConfig) for transmitting the SI request on an initial uplink BWP (where the initial uplink BWP is configured by the IE initialUplinkBWP for a NUL in SIB1) of a normal uplink carrier (NUL). If the field rach-OccasionsSI is absent in this configuration, the UE uses the corresponding parameters configured in the RACH configuration (i.e., rach-ConfigCommon) of the initial uplink BWP of the NUL. There can be several itereations of rach-ConfigCommon in the initial uplink BWP each associated with zero, one or more of the following features, small data transmissions, Msg3 repetitions, RedCap, slicing, Msg1 repetitions. Here the iteration of rach-ConfigCommon which is used for the SI request is the one which is not associated with any feature.
A 2^{nd} SI request configuration (e.g., si-RequestConfigSUL) for transmitting the SI request on an initial uplink BWP (where the initial uplink BWP is configured by the IE initialUplinkBWP for a SUL in SIB1) of a supplementary uplink carrier (SUL). If the field rach-OccasionsSI is absent in this configuration, the UE uses the corresponding parameters configured in the RACH configuration (i.e., rach-ConfigCommon) of the initial uplink BWP of the SUL. There can be several iterations of rach-ConfigCommon in the initial uplink BWP each associated with zero, one or more of the following features, small data transmissions, Msg3 repetitions, RedCap, slicing, Msg1 repetitions. Here the iteration of rach-ConfigCommon which is used for the SI request is the one which is not associated with any feature.
A 3^{rd} SI request configuration (e.g., si-RequestConfigRedcap) for transmitting the SI request on a RedCap specific initial uplink BWP (where the RedCap specific initial uplink BWP is configured by the IE initiall/plinkBWP-RedCap for a NUL in SIB1) of a normal uplink carrier (NUL). If the field rach-OccasionsSI is absent in this configuration, the UE uses the corresponding parameters configured in the RACH configuration (i.e., rach-ConfigCommon) of the RedCap specific initial uplink BWP of the NUL. There can be several iterations rach-ConfigCommon in the initial uplink BWP each associated with zero, one or more of the following features, small data transmissions, Msg3 repetitions, RedCap, slicing, Msg1 repetitions. Here the iteration of rach-ConfigCommon which is used for the SI request is the one which is not associated with any feature.

Each of the above first, 2^{nd} and 3^{rd} SI request configuration includes:
rach-OccasionsSI: the configuration of dedicated RACH Occasions for SI.
si-RequestPeriod: the periodicity of the SI-Request configuration in number of association periods

si-RequestResources: the list of SI request resources. If there is only one entry in the list, the configuration is used for all SI messages for which broadcast status is set to notBroadcasting. Otherwise, the 1^{st} entry in the list corresponds to the first SI message for which broadcast status is set to notBroadcasting, the 2^{nd} entry in the list corresponds to the second SI message for which broadcast status is set to notBroadcasting and so on. The broadcast status for each SI message is indicated in the SIB1.

Each SI request resourcecomprises:
ra-PreambleStartIndex: if N SSBs are associated with a RACH occasion, where N>=1, for the i-th SSB (i=0, . . . , N−1) the preamble with preamble index=ra-PreambleStartIndex+i is used for the SI request; For N<1, the preamble with preamble index=ra-PreambleStartIndex is used for the SI request
ra-AssociationPeriodIndex: the index of the association period in the si-RequestPeriod in which the UE can send the SI request for SI message(s) corresponding to this SI-RequestResources, using the preambles indicated by ra-PreambleStartIndex and rach occasions indicated by ra-ssb-OccasionMaskIndex. Association periods in si-RequestPeriod are indexed sequentially from 0.
ra-ssb-OccasionMaskIndex/ra-ssb-OccasionGroupMaskIndex:
   if the RACH configuration (i.e., rach-ConfigCommon) selected for the SI request procedure is associated with no Msg1 Repetitions:
      ROs associated with same SSB are sequentially indexed. ra-ssb-OccasionMaskIndex indicates which RO(s) amongst the ROs associated with the SSB the UE can use. ra-ssb-OccasionMaskIndex indicates whether the UE uses a specific RO, even RO, odd RO or all ROs.
   if the RACH configuration (i.e., rach-ConfigCommon) selected for the SI request procedure is associated with Msg1 Repetitions:
      The RO groups associated with same SSB are sequentially indexed. ra-ssb-OccasionGroupMaskIndex indicates which RO group(s) amongst the RO groups associated with the SSB the UE can use. It indicates whether the UE uses a specific RO group, even RO group, odd RO group or all RO groups. ra-ssb-OccasionMaskIndex can be set to zero to indicate that the UE can use all RO groups. ra-ssb-OccasionGroupMaskIndex can be set to a pre-defined value (e.g., 8) to indicate that the UE can use even RO groups. ra-ssb-OccasionMaskIndex can be set to a pre-defined value (e.g., 9) to indicate that the UE can use odd RO groups. ra-ssb-OccasionMaskIndex can be set to a pre-defined value range (e.g., 1 to 7) to indicate that UE can use the RO group with the index given ra-ssb-OccasionMaskIndex.

In one embodiment, if the set of random-access resources for 8 Msg1 repetitions is configured in the BWP and if the RSRP of the downlink pathloss reference <rsrp-ThresholdPRACHRepetitons for 8 Msg1 repetitions; or if the BWP is configured only with the set of random-access resources for 8 Msg1 repetitions, the Criteria for 8 Msg1 repetitions is met.

Otherwise, if the set of random-access resources for 4 Msg1 repetitions is configured in the BWP and if the RSRP of the downlink pathloss reference <rsrp-ThresholdPRACHRepetitons for 4 Msg1 repetitions; or if the BWP is configured only with the set of random-access resources for 4 Msg1 repetitions, the criteria for 4 Msg1 repetitions is met.

Otherwise, if the set of random-access resources for 2 Msg1 repetitions is configured in the BWP and if the RSRP of the downlink pathloss reference <rsrp-ThresholdPRACHRepetitons for 2 Msg1 repetitions; or if the BWP is configured only with the set of random-access resources for 2 Msg1 repetitions, the criteria for 2 Msg1 repetitions is met.

Otherwise, the criterion for no repetitions is met.

In one embodiment, rsrp-ThresholdPRACHRepetitons for 2/4/8 Msg1 repetitions are received by the UE from the gNB (e.g., in system information such as a SIB1).

In one embodiment, if the cell is configured with supplementary uplink and if the RSRP of the downlink pathloss reference is less than rsrp-ThresholdSSB-SUL, the UE selects the SUL carrier for performing the random access procedure. Otherwise, the UE selects the NUL carrier for performing random access procedure.

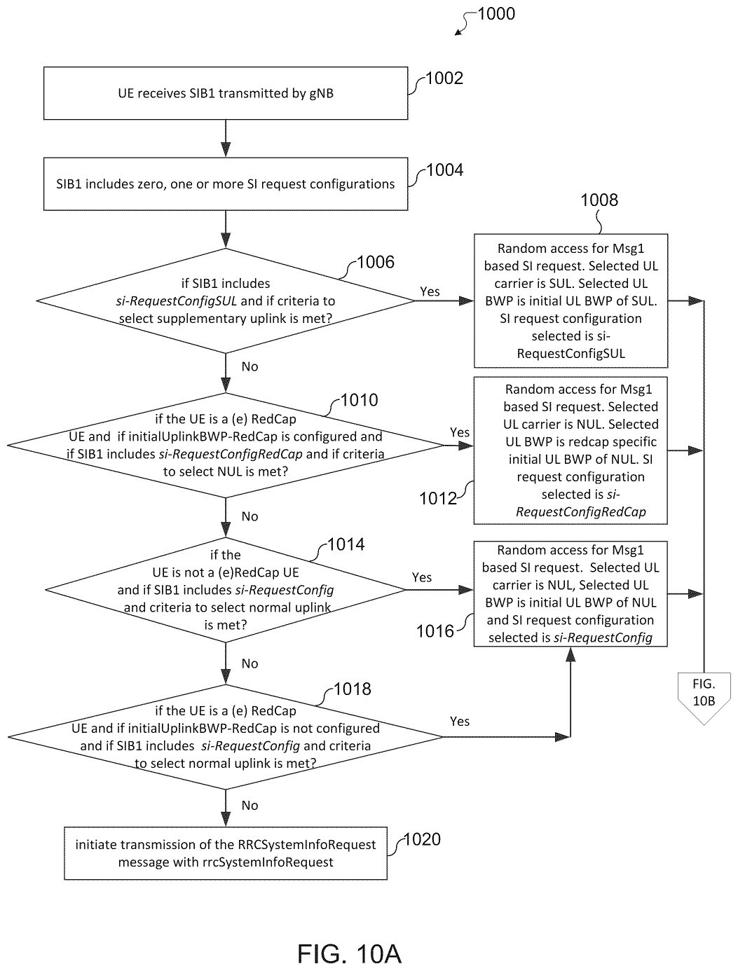

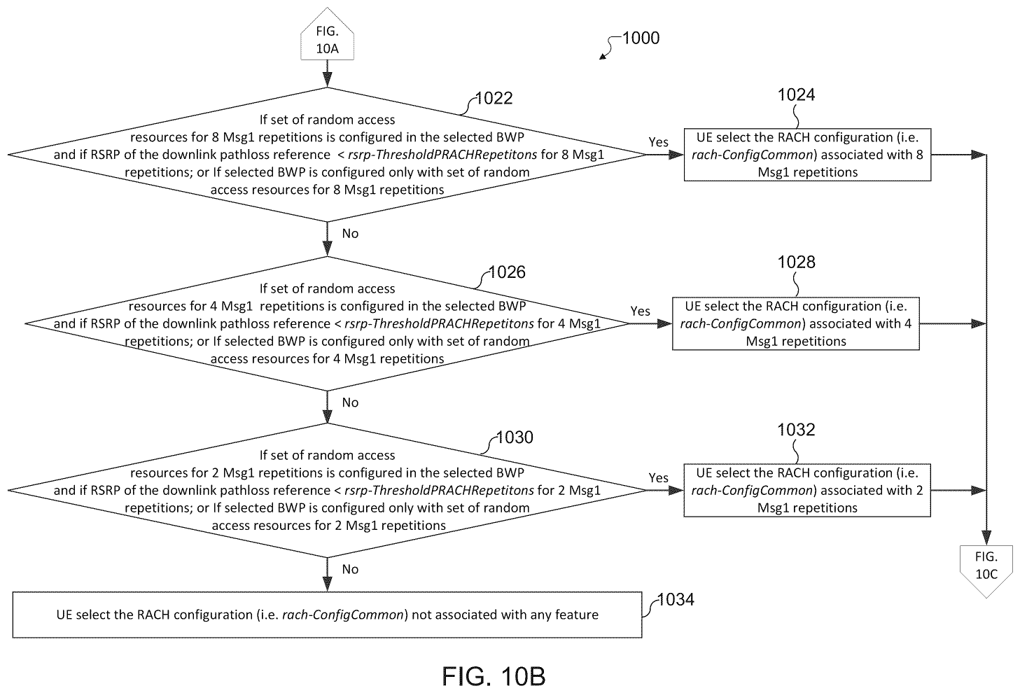

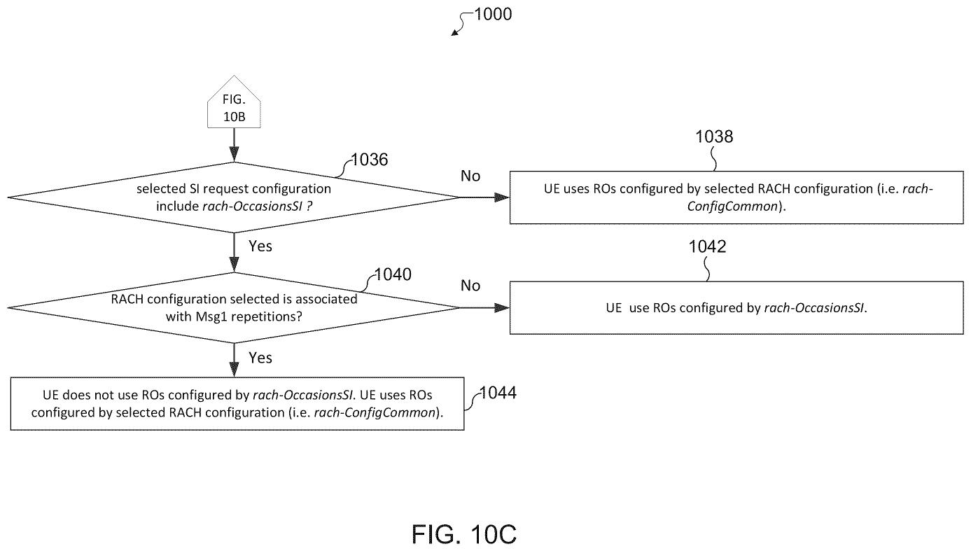

The UE acquires one or more SI messages for which the broadcast status is set to not broadcasting. The UE determines whether to perform a Msg1 based SI request (i.e., a PRACH preamble transmitted by UE indicates the SI message(s) requested by UE) or a Msg3 based SI request (a RRCSystemInformation request message is transmitted in Msg3 where the message includes information about the SI messages/SIBs requested by the UE) as shown in FIGS. 10A-10C.

FIGS. 10A-10C illustrate a method 1000 for requesting system information according to embodiments of the present disclosure. An embodiment of the method illustrated in FIGS. 10A-10C are for illustration only. One or more of the components illustrated in FIGS. 10A-10C may be implemented in specialized circuitry configured to perform the noted functions or one or more of the components may be implemented by one or more processors executing instructions to perform the noted functions. Other embodiments for requesting system information could be used without departing from the scope of this disclosure.

In the example of FIGS. 10A-10C, the method begins as step 1002. At step 1002, a UE such as UE 116 of FIG. 1 receives a SIB1 transmitted by a gNB, such as BS 103 of FIG. 1. At step 1004, the SIB1 includes zero, one, or more SI request configurations.

At step 1006, if the SIB1 includes si-SchedulingInfo containing si-RequestConfigSUL (or the SIB1 includes the 2^{nd} SI request configuration) and the criteria to select the supplementary uplink is met, the method proceeds to step 1008. Otherwise, the method proceeds to step 1010.

At step 1008, for a Msg1 based SI request, the selected UL carrier is the SUL, the selected UL BWP is the initial UL BWP of the SUL and the SI request configuration selected is si-RequestConfigSUL. The UE triggers the lower layer i.e., MAC to initiate the random access procedure on the supplementary uplink using the PRACH preamble(s) and PRACH resource(s) in si-RequestConfigSUL corresponding to the SI message(s) that the UE uses to operate within the cell, and for which si-BroadcastStatus is set to notBroadcasting. During the random access procedure, the UE selects a SSB, and the UE selects a preamble corresponding to the selected SSB based on ra-Preamble StartIndex. The UE selects a RO and transmits a Msg1 i.e., a random access preamble. The UE monitors for an SI request ack after transmitting the Msg1. The preamble is transmitted on the SUL's initial uplink BWP. If acknowledgement for the SI request is received from the lower layers i.e., MAC (during the random access procedure initiated for the SI request based on the SI request configuration, acknowledgment for the SI request is a random access response, a MAC PDU for the random access response includes a MAC sub pdu with a header only where the header includes a RAPID of the transmitted preamble). The UE acquires the requested SI message(s) by monitoring the SI window(s) associated with the requested SI message(s) immediately.

At step 1010, if the UE is a RedCap UE and if initiallJplinkBWP-RedCap is configured and if the SIB1 includes si-SchedulingInfo containing si-RequestConfigRedCap (or the SIB1 includes the 3^{rd} SI request configuration) and the criteria to select the normal uplink is met, the method proceeds to step 1012. Otherwise, the method proceeds to step 1014.

At step 1012, for a Msg1 based SI request, the selected UL carrier is the NUL, the selected UL BWP is the RedCap specific initial UL BWP of the NUL, and the SI request configuration selected is si-RequestConfigRedCap. The UE triggers the lower layer to initiate the random access procedure on the normal uplink using the PRACH preamble(s) and PRACH resource(s) in si-RequestConfigRedcap corresponding to the SI message(s) that the UE uses to operate within the cell, and for which si-BroadcastStatus is set to notBroadcasting. During the random access procedure, the UE selects a SSB, and the UE selects a preamble corresponding to the selected SSB based on ra-PreambleStartIndex. The UE selects a RO and transmits a Msg1 i.e., a random access preamble. The UE monitors for an SI request ack after transmitting the Msg1. The preamble is transmitted on the NUL's RedCap specific initial uplink BWP. If acknowledgement for the SI request is received from the lower layers i.e., MAC (during the random access procedure initiated for the SI request based on the SI request configuration, acknowledgment for the SI request is a random access response, a MAC PDU for the random access response includes a MAC sub pdu with a header only where the header includes a RAPID of the transmitted preamble) the UE acquires the requested SI message(s) by monitoring the SI window(s) associated with the requested SI message(s) immediately.

At step 1014, if the UE is not a RedCap UE and if the SIB1 includes si-SchedulingInfo containing si-RequestConfig (or the SIB1 includes Ist SI request configuration) and the criteria to select the normal uplink is met, the method proceeds to step 1016. Otherwise, the method proceeds to step 1018.

At step 1018, if the UE is a RedCap UE and if initiallyplinkBWP-RedCap is not configured and if the SIB1 includes si-SchedulingInfo containing si-RequestConfig (or the SIB1 includes 1^{st} SI request configuration) and the criteria to select the normal uplink is met, the method proceeds to step 1016. Otherwise, the method proceeds to step 1020.

At step 1016, for a Msg1 based SI request, the selected UL carrier is the NUL, the selected UL BWP is the initial UL BWP of the NUL, and the SI request configuration selected is si-RequestConfig. The UE triggers the lower layer i.e., MAC to initiate the random access procedure on the supplementary uplink using the PRACH preamble(s) and PRACH resource(s) in si-RequestConfig corresponding to the SI message(s) that the UE uses to operate within the cell, and for which si-BroadcastStatus is set to notBroadcasting. During the random access procedure, the UE selects a SSB, and the UE selects a preamble corresponding to the selected SSB based on ra-Preamble StartIndex. The UE selects a RO and transmits a Msg1 i.e., a random access preamble. The UE monitors for an SI request ack after transmitting the Msg1. If acknowledgement for the SI request is received from the lower layers i.e., MAC (during the random access procedure initiated for the SI request based on the SI request configuration, acknowledgment for the SI request is a random access response, a MAC PDU for the random access response includes a MAC sub pdu with a header only where the header includes a RAPID of the transmitted preamble), the UE acquires the requested SI message(s) by monitoring the SI window(s) associated with the requested SI message(s) immediately.

At step 1020, the UE applies the default L1 parameter values as specified in corresponding physical layer specifications except for the parameters for which values are provided in the SIB1. The UE applies the default MAC Cell Group configuration. The UE applies the time AlignmentTimerCommon included in the SIB1. The UE applies the CCCH configuration. The UE initiates transmission of the RRCSystemInfoRequest message with rrcSystemInfoRequest. If acknowledgement for the RRCSystemInfoRequest message with rrcSystemInfoRequest is received from lower layers, the UE acquires the requested SI message(s), immediately.

Upon initiation of a random access procedure for a Msg1 based SI request (as explained above) on the selected UL BWP of the selected carrier, random access parameters other than those configured in the selected SI request configuration are obtained from the RACH configuration (i.e., rach-ConfigCommon) of the selected UL BWP of selected carrier. There can be several RACH configurations (i.e., rach-ConfigCommon) in the selected UL BWP (initial UL BWP or RedCap specific initial UL BWP) of the selected carrier (SUL or NUL) and UE selects the configuration as follows:

At step 1022, if the set of random access resources for 8 Msg1 repetitions is configured in the selected BWP and if the RSRP of the downlink pathloss reference <rsrp-ThresholdPRACHRepetitons for 8 Msg1 repetitions; or if the selected BWP is configured only with the set of random access resources for 8 Msg1 repetitions, the method proceeds to step 1024. Otherwise, the method proceeds to step 1026.

At step 1024, the UE selects the RACH configuration (i.e., rach-ConfigCommon) associated with 8 Msg1 repetitions (or the UE selects the RACH configuration (i.e., rach-Config Common) associated with 8 Msg1 repetitions only).

At step 1026, if the set of random-access resources for 4 Msg1 repetitions is configured in the selected BWP and if the RSRP of the downlink pathloss reference <rsrp-ThresholdPRACHRepetitons for 4 Msg1 repetitions; or if the selected BWP is configured only with the set of random-access resources for 4 Msg1 repetitions, the method proceeds to step 1028. Otherwise, the method proceeds to step 1030.

At step 1028, the UE selects the RACH configuration (i.e., rach-ConfigCommon) associated with 4 Msg1 repetitions (or the UE selects the RACH configuration (i.e., rach-ConfigCommon) associated with 4 Msg1 repetitions only).

At step 1030, the if the set of random-access resources for 2 Msg1 repetitions is configured in the selected BWP and if the RSRP of the downlink pathloss reference <rsrp-ThresholdPRACHRepetitons for 2 Msg1 repetitions; or if the selected BWP is configured only with the set of random-access resources for 2 Msg1 repetitions, the method proceeds to step 1032. Otherwise, the method proceeds to step 1034.

At step 1032, the UE selects the RACH configuration (i.e., rach-ConfigCommon) associated with 2 Msg1 repetitions (or the UE selects the RACH configuration (i.e., rach-Config Common) associated with 8 Msg1 repetitions only).

At step 1034, the UE selects the RACH configuration (i.e., rach-ConfigCommon) not associated with any feature.

At step 1036, if the selected SI request configuration includes rach-OccasionsSI, the method proceeds to step 1040. Otherwise, the method proceeds to step 1038.

At step 1040, if the RACH configuration (i.e., rach-Config (ommon) selected above is associated with Msg1 repetitions the method proceeds to step 1044. Otherwise, the method proceeds to step 1042.

In one embodiment, at step 1044, the UE does not use ROs configured by rach-OccasionsSI. The UE uses ROs configured by the selected RACH configuration (i.e., rach-Config Common). The UE determines ROs based on the PRACH configuration index in the selected RACH configuration. Amongst these ROs, the UE selects RO(s) for preamble transmission based on ra-AssociationPeriodIndex, si-RequestPeriod and ra-ssb-OccasionGroupMaskIndex/ra-ssb-OccasionMaskIndex, if configured in selected SI request configuration.

In another embodiment, at step 1044, the UE uses ROs configured by the selected RACH configuration (i.e., rach-ConfigCommon). The UE determines ROs based on the PRACH configuration index in the selected RACH configuration. ra-AssociationPeriodIndex, si-RequestPeriod and ra-ssb-OccasionGroupMaskIndex/ra-ssb-OccasionMaskIndex, if configured in the selected SI request configuration are not applied to select the ROs.

At step 1038, the UE uses ROs configured by rach-OccasionsSI. The UE determines ROs based on PRACH configuration index in rach-OccasionsSI. Amongst these ROs, the UE selects RO(s) for preamble transmission based on ra-AssociationPeriodIndex, si-RequestPeriod and ra-ssb-OccasionGroupMaskIndex/ra-ssb-OccasionMaskIndex, if configured in selected SI request configuration.

At step 1042, the UE uses ROs configured by the selected RACH configuration (i.e., rach-ConfigCommon). The UE determines ROs based on PRACH configuration index in the selected RACH configuration. Amongst these ROs, the UE select RO(s) for preamble transmission based on ra-AssociationPeriodIndex, si-RequestPeriod and ra-ssb-OccasionGroupMaskIndex/ra-ssb-OccasionMaskIndex, if configured in selected SI request configuration.

Although FIGS. 10A-10C illustrate one example of a method 1000 for requesting system information, various changes may be made to FIGS. 10A-10C. For example, while shown as a series of steps, various steps in FIGS. 10A-10C could overlap, occur in parallel, occur in a different order, occur any number of times, be omitted, or replaced by other steps.

In one embodiment, a UE is camped to a cell. The UE receives/acquires/obtains a system information block 1 (SIB1) from the cell, transmitted by a gNB of the cell. The SIB1 includes information regarding the availability and scheduling (e.g., mapping of SIBs to SI message, periodicity, SI-window size) of other SIBs with an indication whether one or more SIBs/SI messages are only provided on-demand, and, in that case, the configuration needed by the UE to perform the SI request.

The SIB1 may include zero, one or more of the following SI request configurations:
A first SI request configuration (e.g., si-RequestConfig) for transmitting the SI request on an initial uplink BWP (where the initial uplink BWP is configured by the IE initialUplinkBWP for a NUL in SIB1) of a normal uplink carrier (NUL). If the field rach-OccasionsSI is absent in this configuration, the UE uses the corresponding parameters configured in the RACH configuration (i.e., rach-ConfigCommon) of the initial uplink BWP of NUL. There can be several iterations of rach-ConfigCommon in the initial uplink BWP each associated with zero, one or more of the following features, small data transmissions, Msg3 repetitions, RedCap, slicing, and Msg1 repetitions. Here the iteration of rach-ConfigCommon which is used for the SI request is the one which is not associated with any feature.
A 2^{nd} SI request configuration (e.g., si-RequestConfigSUL) for transmitting the SI request on an initial uplink BWP (where the initial uplink BWP is configured by the IE initialUplinkBWP for a SUL in SIB1) of a supplementary uplink carrier (SUL). If the field rach-OccasionsSI is absent in this configuration, the UE uses the corresponding parameters configured in the RACH configuration (i.e., rach-ConfigCommon) of the initial uplink BWP of SUL. There can be several iterations of rach-ConfigCommon in the initial uplink BWP each associated with zero, one or more of the following features, small data transmissions, Msg3 repetitions, RedCap, slicing, and Msg1 repetitions. Here the iteration of rach-ConfigCommon which is used for the SI request is the one which is not associated with any feature.
A 3^{rd} SI request configuration (e.g., si-RequestConfigRedcap) for transmitting the SI request on a RedCap specific initial uplink BWP (where the RedCap specific initial uplink BWP is configured by the IE initiallJplinkBWP-RedCap for a NUL in SIB1) of a normal uplink carrier (NUL). If the field rach-OccasionsSI is absent in this configuration, the UE uses the corresponding parameters configured in the RACH configuration (i.e., rach-ConfigCommon) of the RedCap specific initial uplink BWP of NUL. There can be several iterations of rach-ConfigCommon in the initial uplink BWP each associated with zero, one or more of the following features, small data transmissions, Msg3 repetitions, RedCap, slicing, and Msg1 repetitions. Here the iteration of rach-ConfigCommon which is used for the SI request is the one which is not associated with any feature.

Each of the above first, 2^{nd} and 3^{rd} SI request configuration includes:
rach-OccasionsSI: the configuration of dedicated RACH Occasions for SI.
si-RequestPeriod: the periodicity of the SI-Request configuration in number of association periods

si-RequestResources: the list of SI request resources. If there is only one entry in the list, the configuration is used for all SI messages for which broadcast status is set to notBroadcasting. Otherwise, the 1^{st} entry in the list corresponds to the first SI message for which broadcast status is set to notBroadcasting, the 2^{nd} entry in the list corresponds to the second SI message for which broadcast status is set to notBroadcasting and so on. The broadcast status for each SI message is indicated in SIB1.

Each SI request resource comprises:
ra-PreambleStartIndex: if N SSBs are associated with a RACH occasion, where N>=1, for the i-th SSB (i=0, . . . , N−1) the preamble with preamble index=ra-PreambleStartIndex+i is used for the SI request; For N<1, the preamble with preamble index=ra-PreambleStartIndex is used for the SI request
ra-AssociationPeriodIndex: the index of the association period in the si-RequestPeriod in which the UE can send the SI request for SI message(s) corresponding to this SI-RequestResources, using the preambles indicated by ra-PreambleStartIndex and rach occasions indicated by ra-ssb-OccasionMaskIndex. Association periods in si-RequestPeriod are indexed sequentially from 0.
ra-ssb-OccasionMaskIndex/ra-ssb-OccasionGroupMaskIndex:
   if the RACH configuration (i.e., rach-ConfigCommon) selected for the SI request procedure is associated with no Msg1 Repetitions:
      ROs associated with the same SSB are sequentially indexed. ra-ssb-OccasionMaskIndex indicates which RO(s) amongst the ROs associated with SSB the UE can use. ra-ssb-OccasionMaskIndex indicates whether the UE uses a specific RO, even RO, odd RO or all ROs.
   if the RACH configuration (i.e., rach-ConfigCommon) selected for the SI request procedure is associated with Msg1 Repetitions:
      The RO groups associated with same SSB are sequentially indexed. ra-ssb-OccasionGroupMaskIndex indicates which RO group(s) amongst the RO groups associated with the SSB the UE can use. It indicates whether the UE uses a specific RO group, even RO group, odd RO group or all RO groups. ra-ssb-OccasionMaskIndex can be set to zero to indicate that UE can use all RO groups. ra-ssb-OccasionGroupMaskIndex can be set to a pre-defined value (e.g., 8) to indicate that UE can use even RO groups. ra-ssb-OccasionMaskIndex can be set to a pre-defined value (e.g., 9) to indicate that UE can use odd RO groups. ra-ssb-OccasionMaskIndex can be set to a pre-defined value range (e.g., 1 to 7) to indicate that UE can use the RO group with the index given ra-ssb-OccasionMaskIndex.

In one embodiment, if the set of random access resources for 8 Msg1 repetitions is configured in the BWP and if the RSRP of the downlink pathloss reference <rsrp-ThresholdPRACHRepetitons for 8 Msg1 repetitions; or if the BWP is configured only with the set of random access resources for 8 Msg1 repetitions, the criteria for 8 Msg1 repetitions is met.

Otherwise, if the set of random access resources for 4 Msg1 repetitions is configured in the BWP and if the RSRP of the downlink pathloss reference <rsrp-ThresholdPRACHRepetitons for 4 Msg1 repetitions; or if the BWP is configured only with the set of random access resources for 4 Msg1 repetitions, the criteria for 4 Msg1 repetitions is met.

Otherwise, if the set of random-access resources for 2 Msg1 repetitions is configured in the BWP and if the RSRP of the downlink pathloss reference <rsrp-ThresholdPRACHRepetitons for 2 Msg1 repetitions; or if the BWP is configured only with set of random-access resources for 2 Msg1 repetitions, the criteria for 2 Msg1 repetitions is met.

Otherwise, the criteria for no Msg1 repetitions is met.

If the criteria for any number (2/4/8) of Msg1 repetitions is not met for a BWP, the UE considers that criteria for Msg1 repetitions is not met for that BWP.

In one embodiment, rsrp-ThresholdPRACHRepetitons for 2/4/8 Msg1 repetitions are received by the UE from the gNB (e.g., in system information such as a SIB1).

In one embodiment, if a cell is configured with a supplementary uplink and if the RSRP of the downlink pathloss reference is less than rsrp-ThresholdSSB-SUL, the UE selects the SUL carrier for performing random access procedure. Otherwise, the UE selects the NUL carrier for performing random access procedure.

The UE needs acquires one or more SI messages for which broadcast status is set to not broadcasting. The UE determines whether to perform a Msg1 based SI request (Msg1 i.e., PRACH preamble transmitted by UE indicates the SI message(s) requested by UE) or a Msg3 based SI request (RRCSystemInformation request message is transmitted in Msg3 where the message includes information about the SI messages/SIBs requested by the UE) as follows:

If the SIB1 includes si-SchedulingInfo containing si-RequestConfigSUL (or the SIB1 includes 2^{nd} SI request configuration) and the criteria to select the supplementary uplink is met and the criteria for Msg1 repetitions is not met (or the criteria for Msg1 repetitions on SUL's initial UL BWP (i.e., initial (plinkBWP) is not met), for a Msg1 based SI request, the selected UL carrier is the SUL, the selected UL BWP is the initial UL BWP of the SUL and the SI request configuration selected is si-RequestConfigSUL. The UE triggers the lower layer i.e., MAC to initiate the random access procedure on the supplementary uplink using the PRACH preamble(s) and PRACH resource(s) in si-RequestConfigSUL corresponding to the SI message(s) that the UE uses to operate within the cell, and for which si-BroadcastStatus is set to notBroadcasting. During the random access procedure, the UE selects a SSB, and the UE selects a preamble corresponding to the selected SSB based on ra-PreambleStartIndex. The UE selects a RO and transmits a Msg1 i.e., a random access preamble. The UE monitors for an SI request ack after transmitting the Msg1. The preamble is transmitted on the SUL's initial uplink BWP. If acknowledgement for the SI request is received from the lower layers i.e., MAC (during the random access procedure initiated for the SI request based on the SI request configuration, acknowledgment for the SI request is a random access response, a MAC PDU for the random access response includes a MAC sub pdu with a header only where the header includes a RAPID of the transmitted preamble), The UE acquires the requested SI message(s) by monitoring the SI window(s) associated with the requested SI message(s) immediately.

Otherwise, if the UE is a RedCap UE and if initiallJplinkBWP-RedCap is configured and if the SIB1 includes si-SchedulingInfo containing si-RequestConfigRedCap (or the SIB1 includes 3^{rd} SI request configuration) and the criteria to select the normal uplink is met and the criteria for Msg1 repetitions is not met (or the criteria for Msg1 repetitions on the normal uplink's RedCap specific initial UL BWP (i.e., initiallyplinkBWP-RedCap) is not met), for a Msg1 based SI request, the selected UL carrier is the NUL, the selected UL BWP is the RedCap specific initial UL BWP of the NUL and the SI request configuration selected is si-RequestConfigRedCap. The UE triggers the lower layer to initiate the random access procedure on the normal uplink using the PRACH preamble(s) and PRACH resource(s) in si-RequestConfigRedcap corresponding to the SI message(s) that the UE uses to operate within the cell, and for which si-BroadcastStatus is set to notBroadcasting. During the random access procedure, the UE selects a SSB, and the UE selects a preamble corresponding to the selected SSB based on ra-PreambleStartIndex. The UE selects a RO and transmits a Msg1 i.e., a random access preamble. The UE monitors for an SI request ack after transmitting the Msg1. The preamble is transmitted on the NUL's RedCap specific initial uplink BWP. If acknowledgement for the SI request is received from the lower layers i.e., MAC (during the random access procedure initiated for the SI request based on the SI request configuration, acknowledgment for the SI request is a random access response, a MAC PDU for the random access response includes a MAC sub pdu with a header only where the header includes a RAPID of the transmitted preamble), the UE acquires the requested SI message(s) by monitoring the SI window(s) associated with the requested SI message(s) immediately.

Otherwise, if the UE is not a RedCap UE and if the SIB1 includes si-SchedulingInfo containing si-RequestConfig (or the SIB1 includes 1^{st} SI request configuration) and the criteria to select the normal uplink is met and the criteria for Msg1 repetitions is not met (or the criteria for Msg1 repetitions on the NUL's initial UL BWP (i.e., initiallJplinkBWP) is not met); or if the UE is a RedCap UE and if initiallplinkBWP-RedCap is not configured and if the SIB1 includes si-SchedulingInfo containing si-RequestConfig (or the SIB1 includes 1^{st} SI request configuration) and the criteria to select the normal uplink is met and the criteria for Msg1 repetitions is not met (or the criteria for Msg1 repetitions on the NUL's initial UL BWP is not met); for a Msg1 based SI request, the selected UL carrier is the NUL, the selected UL BWP is the initial UL BWP of the NUL and the SI request configuration selected is si-RequestConfig. The UE triggers the lower layer i.e., MAC to initiate the random access procedure on the supplementary uplink using the PRACH preamble(s) and PRACH resource(s) in si-RequestConfig corresponding to the SI message(s) that the UE uses to operate within the cell, and for which si-BroadcastStatus is set to notBroadcasting. During the random access procedure, the UE selects a SSB, and the UE selects a preamble corresponding to the selected SSB based on ra-PreambleStartIndex. The UE selects a RO and transmits a Msg1 i.e., a random access preamble. The UE monitors for an SI request ack after transmitting the Msg1. If acknowledgement for the SI request is received from the lower layers i.e., MAC (during the random access procedure initiated for the SI request based on the SI request configuration, acknowledgment for the SI request is a random access response, a MAC PDU for the random access response includes a MAC sub pdu with a header only where the header includes a RAPID of the transmitted preamble), The UE acquires the requested SI message(s) by monitoring the SI window(s) associated with the requested SI message(s) immediately.

Otherwise, the UE applies the default L1 parameter values as specified in corresponding physical layer specifications except for the parameters for which values are provided in the SIB1. The UE applies the default MAC Cell Group configuration. The UE applies the time Alignment TimerCommon included in the SIB1. The UE applies the CCCH configuration. The UE initiates transmission of the RRCSystemInfoRequest message with rrcSystemInfoRequest. If acknowledgement for RRCSystemInfoRequest message with rrcSystemInfoRequest is received from lower layers, the UE acquires the requested SI message(s), immediately.

Upon initiation of a random access procedure for the Msg1 based SI request (as explained above) on the selected UL BWP of the selected carrier, random access parameters other than those configured in selected SI request configuration are obtained from the RACH configuration (i.e., rach-ConfigCommon) of the selected UL BWP of the selected carrier. There can be several RACH configurations (i.e., rach-ConfigCommon) in the selected UL BWP (initial UL BWP or RedCap specific initial UL BWP) of the selected carrier (SUL or NUL) and the UE selects the RACH configuration (i.e., rach-ConfigCommon) not associated with any feature.

In one embodiment, for multiple Msg1 repetitions, valid ROs are grouped where the group includes N ROs, and N is the number of Msg1 repetitions. RO groups are then mapped to all transmitted SSBs in the cell. This mapping of RO groups to SSBs can be done over a period. This period can be referred as an association period or RO group association period or by any other name. One or more SSBs can be associated to each RO group. There can be several RO groups per SSB in an association period or period over which ROs are grouped and mapped to SSBs.

In one embodiment, the RO groups associated with the same SSB can be sequentially indexed. In one embodiment, different RO groups of the same SSB are assigned to different UEs for contention free random access with multiple Msg1 repetitions. A parameter can be signaled in the contention free random access configuration by the gNB which indicates which RO group(s) amongst the RO groups associated with the SSB, the UE is allowed to use. The name of this parameter can be ra-ssb-OccasionGroupMaskIndex, or it can be any other name.

In one embodiment, for indexing, RO groups associated with same SSB are indexed sequentially, first, in increasing order of frequency resource (indexes) for frequency multiplexed RO groups; and second, in increasing order of time resource (indexes) for time multiplexed RO groups.

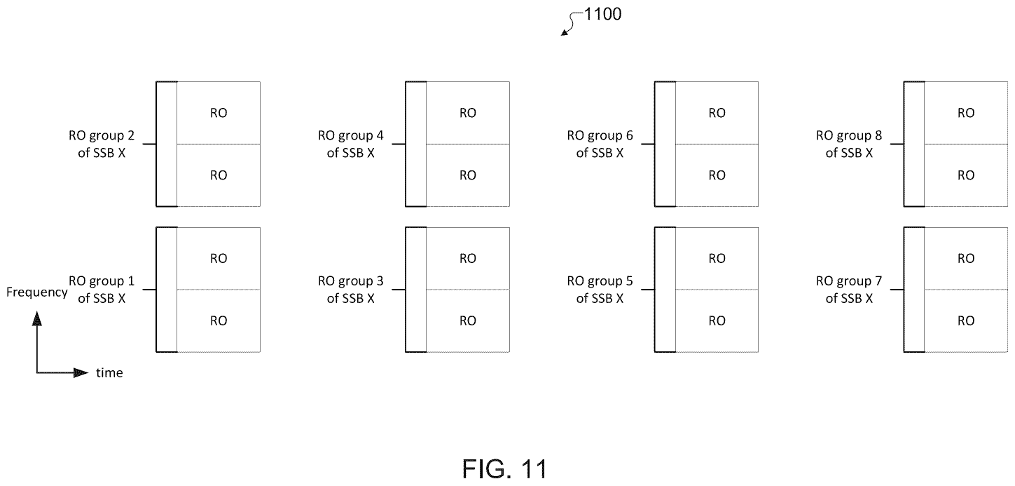

FIG. 11 illustrates an example 1100 of RO grouping according to embodiments of the present disclosure. The embodiment of RO grouping of FIG. 11 is for illustration only. Different embodiments of RO grouping could be used without departing from the scope of this disclosure.

FIG. 11 shows the RO groups of SSB X (X is the index of SSB) in an association period or RO group association period. Multiple RO groups are there in time and frequency. These RO groups of SSB X are indexed sequentially starting from 1, first in the frequency domain and then in the time domain as shown. Note that RO groups of other SSBs (SSBs are other than SSB X) are not shown for simplicity.

Although FIG. 11 illustrates an example 1100 of RO grouping, various changes may be made to FIG. 11. For example, various changes to the number of SSBs, the number of ROs, etc. could be made according to particular needs.

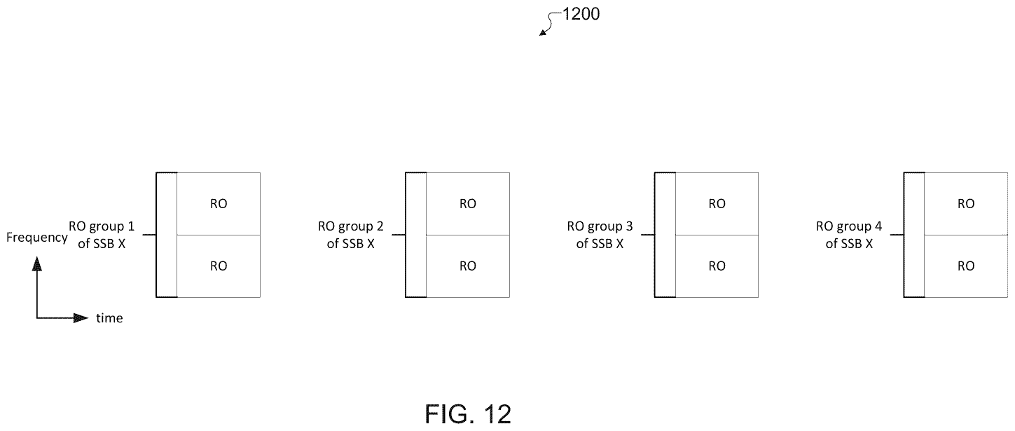

FIG. 12 illustrates another example 1200 of RO grouping according to embodiments of the present disclosure. The embodiment of RO grouping of FIG. 12 is for illustration only. Different embodiments of RO grouping could be used without departing from the scope of this disclosure.

FIG. 12 shows the RO groups of SSB X (X is the index of SSB) in an association period or RO group association period. Multiple RO groups are there in time. These RO groups of SSB X are indexed sequentially starting from 1, in time domain as shown in FIG. 11. Note that RO groups of other SSBs (SSBs are other than SSB X) are not shown for simplicity.

Although FIG. 12 illustrates an example 1200 of RO grouping, various changes may be made to FIG. 12. For example, various changes to the number of SSBs, the number of ROs, etc. could be made according to particular needs.

In one embodiment, the value of ra-ssb-OccasionGroupMaskIndex indicates whether the UE uses a specific RO group or even RO group or odd RO group or all RO groups.

ra-ssb-OccasionGroupMaskIndex can be set to zero to indicate that UE can use or is allowed to use all RO groups, in this case UE will select the earliest available RO group amongst the RO groups corresponding to SSB selected during the contention free random access. The RO groups associated with same SSB are sequentially indexed (within association period or RO group association period or certain pre-defined/configured period).

ra-ssb-OccasionGroupMaskIndex can be set to a pre-defined value (e.g., 8) to indicate that UE can use even RO groups. In this case UE will select the earliest available RO group with even index number amongst the RO groups corresponding to SSB selected during the contention free random access. The RO groups associated with same SSB are sequentially indexed (within association period or RO group association period or certain pre-defined/configured period).

ra-ssb-OccasionGroupMaskIndex can be set to a pre-defined value (e.g., 9) to indicate that UE can use odd RO groups. In this case UE will select the earliest available RO group with odd index number amongst the RO groups corresponding to SSB selected during the contention free random access. The RO groups associated with same SSB are sequentially indexed (within association period or RO group association period or certain pre-defined/configured period).

ra-ssb-OccasionGroupMaskIndex can be set to a pre-defined value range (e.g., 1 to 7) to indicate that UE can use the RO group with index given ra-ssb-OccasionGroupMaskIndex. In this case UE will select the earliest available RO group with index number equal to value of ra-ssb-OccasionGroupMaskIndex amongst the RO groups corresponding to SSB selected during the contention free random access. The RO groups associated with same SSB are sequentially indexed (within association period or RO group association period or certain pre-defined/configured period).

In one embodiment, if the set of random access resources for 8 Msg1 repetitions is configured in the BWP selected for the random access procedure and if the RSRP of the downlink pathloss reference <rsrp-ThresholdPRACHRepetitons for 8 Msg1 repetitions; or if the BWP selected for the random access procedure is configured only with the set of random access resources for 8 Msg1 repetitions, 8 Msg1 repetitions are applied.

Otherwise, if the set of random access resources for 4 Msg1 repetitions is configured in the BWP selected for the random access procedure and if the RSRP of the downlink pathloss reference <rsrp-ThresholdPRACHRepetitons for 4 Msg1 repetitions; or if the BWP selected for the random access procedure is configured only with set of random access resources for 4 Msg1 repetitions, 4 Msg1 repetitions are applied.

Otherwise, if the set of random access resources for 2 Msg1 repetitions is configured in the BWP selected for the random access procedure and if the RSRP of the downlink pathloss reference <rsrp-ThresholdPRACHRepetitons for 2 Msg1 repetitions; or if the BWP selected for the random access procedure is configured only with set of random access resources for 2 Msg1 repetitions, 2 Msg1 repetitions are applied.

Otherwise, the criterion for no repetitions is met.

In one embodiment, for paired spectrum or a supplementary uplink band all ROs are valid. In one embodiment, for unpaired spectrum, RO validity is as specified in TS 38.213.

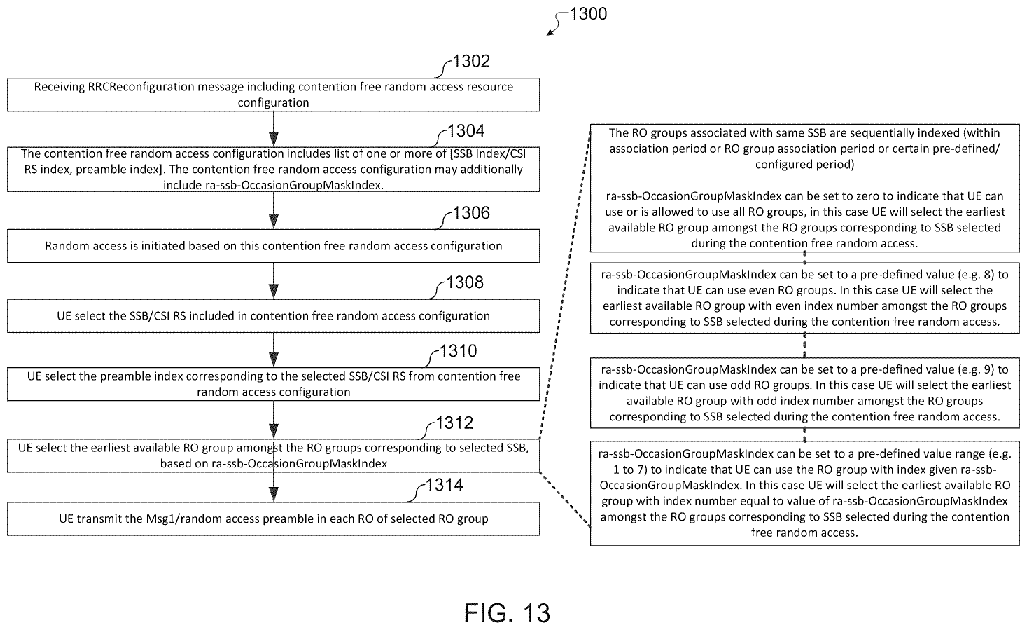

FIG. 13 illustrates a method 1300 for selecting ROs for random access according to embodiments of the present disclosure. An embodiment of the method illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments for selecting ROs for random access could be used without departing from the scope of this disclosure.

In the Example of FIG. 13, the method begins at step 1302. At step 1302 a gNB transmits a contention free random access configuration to a UE. This transmission can be done in RRC signaling message (e.g., in RRCReconfiguration message).

At step 1304, the contention free random access configuration includes list of one or more of [SSB Index/CSI RS index, preamble index]. The contention free random access configuration may additionally include ra-ssb-OccasionGroupMaskIndex. It may also include number of Msg1 repetitions. This contention free random access configuration can be provided to UE for target SpCell in case of handover (or reconfiguration with sync procedure). The contention free random access configuration can be provided to UE for serving SpCell for beam failure recovery.

Upon initiation of random access procedure for handover (or reconfiguration with sync procedure) of target SpCell or for beam failure recovery of SpCell (step 1306), the UE selects the UL carrier and BWP as explained herein.

At step 1308 the UE selects the SSB/CSI RS included in contention free random access configuration if SS-RSRP/CSIRS-RSRP of the SSB/CSI RS in contention free random access configuration is above the threshold (threshold is configured by gNB in RRC signaling).

At step 1310, the UE selects the preamble index corresponding to the selected SSB/CSI RS from contention free random access configuration. Note that preamble index corresponding to SSB/CSI RS is signaled in the contention free random access configuration. For example, the contention free random access configuration may include [preamble 1, SSB 2, RO group index 1] and [preamble 2, SSB 3, RO group index 2]. If the SSB selected is SSB 3, preamble 2 is selected.

The PRACH configuration index may be signaled in the contention free random access configuration. All the configured ROs are determined based on this index. If the PRACH configuration index is not signaled in the contention free random access configuration, the configured ROs are determined based on PRACH configuration index of the RACH configuration in BWP selected for random access procedure.

For multiple Msg1 repetitions, valid ROs amongst the configured ROs are grouped where the group includes N ROs, and N is the number of Msg1 repetitions. RO groups are then mapped to all the transmitted SSBs in the cell. This mapping of RO groups to SSBs can be done over a period. This period can be referred to as an association period or RO group association period or by any other name. One or more SSBs can be associated to each RO group. There can be several RO groups per SSB in an association period or period over which ROs are grouped and mapped to SSBs.

If Msg1 repetition is applied for preamble transmission during this random access procedure (the number of Msg1 repetitions can be indicated by the gNB in the contention free random access configuration or the UE can select based on RSRP threshold as explained earlier), at step 1312, the UE selects the earliest available RO group amongst the RO groups corresponding to select the SSB, based on ra-ssb-OccasionGroupMaskIndex (if configured) as explained herein. For example, the contention free random access configuration may include [preamble 1, SSB 2, RO group index 1] and [preamble 2, SSB 3, RO group index 2]. If the SSB selected is SSB 3, the UE selects the RO group (amongst the odd RO groups or amongst the even RO groups or specific RO group or amongst the all RO groups) corresponding to SSB 3 based on ra-ssb-OccasionGroupMaskIndex.

The UE selects the earliest available RO group amongst all the RO groups corresponding to SSB selected, if ra-ssb-OccasionGroupMaskIndex is not configured.

Finally, at step 1314, the UE transmits the Msg1/random access preamble in each RO of selected RO group.

Although FIG. 13 illustrates one example of a method 1300 for selecting ROs for random access, various changes may be made to FIG. 13. For example, while shown as a series of steps, various steps in FIG. 13 could overlap, occur in parallel, occur in a different order, occur any number of times, be omitted, or replaced by other steps.

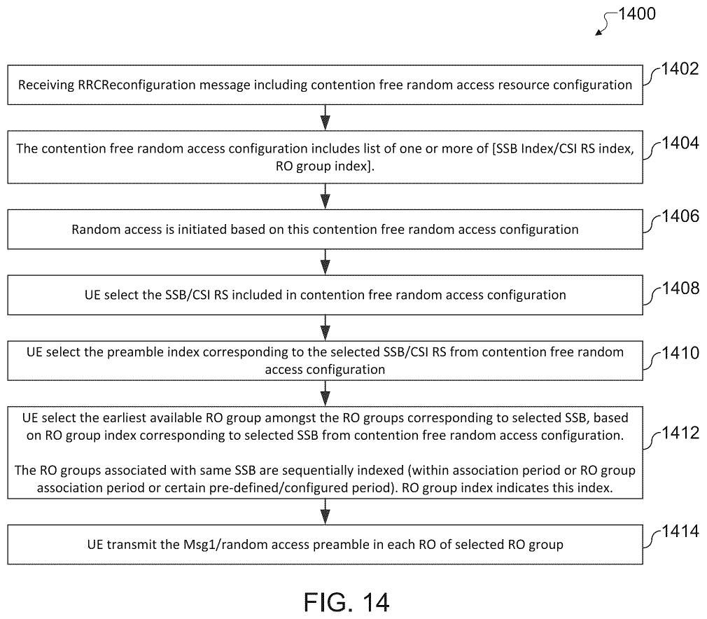

FIG. 14 illustrates another method 1400 for selecting ROs for random access according to embodiments of the present disclosure. An embodiment of the method illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments for selecting ROs for random access could be used without departing from the scope of this disclosure.

In the example of FIG. 14, the method begins at step 1402. At step 1402, a gNB transmits contention free random access configuration to UE. This transmission can be sent in a RRC signaling message (e.g., in RRCReconfiguration message).

At step 1404, the contention free random access configuration includes list of one or more of [SSB Index/CSI RS index, preamble index, RO group index]. It may also include a number of Msg1 repetitions. This contention free random access configuration can be provided to the UE for a target SpCell in case of handover (or reconfiguration with sync procedure). The contention free random access configuration can be provided to the UE for a serving SpCell for beam failure recovery.

Upon initiation of random access procedure for handover (or reconfiguration with sync procedure) of target SpCell or for beam failure recovery of SpCell (step 1406), the UE selects the UL carrier and BWP as explained earlier.

At step 1408, the UE selects the SSB/CSI RS included in the contention free random access configuration if SS-RSRP/CSIRS-RSRP of the SSB/CSI RS in the contention free random access configuration is above the threshold (threshold is configured by gNB in RRC signaling).

At step 1410 the UE selects the preamble index corresponding to the selected SSB/CSI RS from the contention free random access configuration. Note that the preamble index corresponding to SSB/CSI RS is signaled in the contention free random access configuration. For example, the contention free random access configuration may include [preamble 1, SSB 2, RO group index 1] and [preamble 2, SSB 3, RO group index 2]. If the SSB selected is SSB 3, preamble 2 is selected.

The PRACH configuration index may be signaled in the contention free random access configuration. All the configured ROs are determined based on this index. If the PRACH configuration index is not signaled in the contention free random access configuration, the configured ROs are determined based on the PRACH configuration index of RACH configuration in BWP selected for random access procedure.

For multiple Msg1 repetitions, valid ROs amongst the configured ROs are grouped where the group includes N ROs, and N is the number of Msg1 repetitions. RO groups are then mapped to all transmitted SSBs in the cell. This mapping of RO groups to SSBs can be done over a period. This period can be referred to as an association period or RO group association period or by any other name. One or more SSBs can be associated to each RO group. There can be several RO groups per SSB in an association period or period over which ROs are grouped and mapped to SSBs.

If Msg1 repetition is applied for preamble transmission during this random access procedure (number of Msg1 repetition can be indicated by gNB in contention free random access configuration or UE can select based on RSRP threshold as explained earlier), at step 1412, the UE selects the RO group identified by the RO group index (RO group index corresponding to selected SSB is in contention free random access configuration) amongst the RO groups corresponding to the selected SSB. RO groups of the same SSB are indexed sequentially (within association period or RO group association period or certain pre-defined/configured period). For example, the contention free random access configuration may include [preamble 1, SSB 2, RO group index 1] and [preamble 2, SSB 3, RO group index 2]. If the SSB selected is SSB 3, RO group of SSB 3 with RO group index 2 is selected. Alternatively, at step 1412, the UE selects the RO group identified by the RO group index (RO group index corresponding to selected SSB is in contention free random access configuration) amongst all the RO groups. All RO groups are indexed sequentially (within association period or RO group association period or certain pre-defined/configured period). For example, the contention free random access configuration may include [preamble 1, SSB 2, RO group index 1] and [preamble 2, SSB 3, RO group index 2]. If the SSB selected is SSB 3, amongst all RO groups, UE select RO group with RO group index 2.

Finally, at step 1414, the UE transmits the Msg1/random access preamble in each RO of selected RO group.

Although FIG. 14 illustrates one example of a method 1400 for selecting ROs for random access, various changes may be made to FIG. 14. For example, while shown as a series of steps, various steps in FIG. 14 could overlap, occur in parallel, occur in a different order, occur any number of times, be omitted, or replaced by other steps.

In one embodiment, a gNB transmits a contention free random access configuration to a UE. This transmission can be sent in a RRC signaling message (e.g., in RRCReconfiguration message). The contention free random access configuration includes a list of one or more of [SSB Index/CSI RS index, preamble index]. It may also include RO group index. It may also include a number of Msg1 repetitions. This contention free random access configuration can be provided to the UE for a target SpCell in case of handover (or reconfiguration with sync procedure). The contention free random access configuration can be provided to the UE for a serving SpCell for beam failure recovery.

Upon initiation of random access procedure for handover (or reconfiguration with sync procedure) of a target SpCell or for beam failure recovery of a SpCell, the UE selects the UL carrier and BWP as explained herein.

The UE selects the SSB/CSI RS included in the contention free random access configuration if SS-RSRP/CSIRS-RSRP of the SSB/CSI RS in the contention free random access configuration is above the threshold (the threshold is configured by the gNB in RRC signaling).

The UE selects the preamble index corresponding to the selected SSB/CSI RS from the contention free random access configuration. Note that the preamble index corresponding to SSB/CSI RS is signaled in the contention free random access configuration. For example, the contention free random access configuration may include [preamble 1, SSB 2, RO group index 1] and [preamble 2, SSB 3, RO group index 2]. If the SSB selected is SSB 3, preamble 2 is selected.

PRACH configuration index may be signaled in contention free random access configuration. All the configured ROs are determined based on this index. If PRACH configuration index is not signaled in contention free random access configuration, the configured ROs are determined based on the PRACH configuration index of the RACH configuration in the BWP selected for the random access procedure. For multiple Msg1 repetitions, valid ROs amongst the configured ROs are grouped where the group includes N ROs, and N is the number of Msg1 repetitions. RO groups are then mapped to all the transmitted SSBs in the cell. This mapping of RO groups to SSBs can be done over a period. This period can be referred to as an association period or RO group association period or by any other name. One or more SSBs can be associated to each RO group. There can be several RO groups per SSB in an association period or period over which ROs are grouped and mapped to SSBs.

If Msg1 repetition is applied for preamble transmission during this random access procedure (the number of Msg1 repetition can be indicated by gNB in contention free random access configuration or UE can select based on RSRP threshold as explained earlier), the UE selects the RO group identified by the RO group index (the RO group index is in the contention free random access configuration) amongst the RO groups corresponding to the selected SSB. RO groups of the same SSB are indexed sequentially (within an association period or RO group association period or certain pre-defined/configured period). For example, the contention free random access configuration may include [preamble 1, SSB 2] and [preamble 2, SSB 3] and RO group index 2. If the SSB selected is SSB 3, RO group of SSB 3 with RO group index 2 is selected. Alternatively, the UE may select the RO group identified by the RO group index (the RO group index is in contention free random access configuration) amongst all the RO groups. All RO groups are indexed sequentially (within association period or RO group association period or certain pre-defined/configured period). For example, the contention free random access configuration may include [preamble 1, SSB 2] and [preamble 2, SSB 3] and RO group index 2. The UE selects the RO group with RO group index 2.

Finally, the UE transmits the Msg1/random access preamble in each RO of the selected RO group.

In one embodiment, a gNB transmits a PDCCH order to a UE for contention free random access. The PDCCH order includes an SSB Index/CSI RS index, and preamble index. The PDCCH order may additionally include ra-ssb-OccasionGroupMaskIndex. It may also include a number of Msg1 repetitions. Upon initiation of a random access procedure by the PDCCH order which includes a non-zero preamble index:

The UE selects the SSB/CSI RS included in the PDCCH order.

The UE selects the preamble index in the PDCCH order.

ROs are determined based on the PRACH configuration index of the RACH configuration in the BWP selected for random access procedure. For multiple Msg1 repetitions, valid ROs amongst the configured ROs are grouped where the group includes N ROs, and N is the number of Msg1 repetitions. RO groups are then mapped to all the transmitted SSBs in the cell. This mapping of RO groups to SSBs can be done over a period. This period can be referred to as an association period or RO group association period or by any other name. One or more SSBs can be associated to each RO group. There can be several RO groups per SSB in an association period or period over which ROs are grouped and mapped to SSBs.

If Msg1 repetition is applied for the preamble transmission during this random access procedure (the number of Msg1 repetition can be indicated by the gNB in the PDCCH order or the UE can select based on the RSRP threshold as explained herein), the UE selects the earliest available RO group amongst the RO groups corresponding to the SSB selected based on ra-ssb-OccasionGroupMaskIndex (if configured) as explained earlier. The UE selects the earliest available RO group amongst the RO groups corresponding to SSB selected if ra-ssb-OccasionGroupMaskIndex is not included in PDCCH order. Finally, the UE transmits the Msg1/random access preamble in each RO of selected RO group.

In one embodiment, the gNB transmits a PDCCH order to the UE for contention free random access. The PDCCH order includes an SSB Index/CSI RS index, and a preamble index. The PDCCH order may additionally include a RO group index. It may also include a number of Msg1 repetitions. Upon initiation of the random access procedure by the PDCCH order which includes a non-zero preamble index:

The UE selects the SSB/CSI RS included in the PDCCH order.

The UE selects the preamble index in the PDCCH order.

ROs are determined based on the PRACH configuration index of the RACH configuration in BWP selected for random access procedure. For multiple Msg1 repetitions, valid ROs amongst the configured ROs are grouped where a group includes NROs, and N is the number of Msg1 repetitions. RO groups are then mapped to all the transmitted SSBs in the cell. This mapping of RO groups to SSBs can be done over a period. This period can be referred to as an association period or RO group association period or by any other name. One or more SSBs can be associated to each RO group. There can be several RO groups per SSB in an association period or period over which ROs are grouped and mapped to SSBs.

If Msg1 repetition is applied for the preamble transmission during this random access procedure (the number of Msg1 repetition can be indicated by gNB in PDCCH order or UE can select based on RSRP threshold as explained earlier), the UE selects the RO group identified by the RO group index (RO group index corresponding to selected SSB is in PDCCH order) amongst the RO groups corresponding to the selected SSB. RO groups of same SSB are indexed sequentially (within association period or RO group association period or certain pre-defined/configured period). Alternatively, the UE selects the RO group identified by the RO group index (the RO group index is in the PDCCH order) amongst all the RO groups. All RO groups are indexed sequentially (within the association period or RO group association period or certain pre-defined/configured period). The UE selects the earliest available RO group amongst the RO groups corresponding to SSB selected if RO group index is not included in PDCCH order.

Finally, the UE transmits the Msg1/random access preamble in each RO of the selected RO group.

In one embodiment, a UE is in a RRC_CONNECTED state. UE is configured with a connected mode DRX configuration (as described herein) using RRC signaling. For network energy savings, Cell DTX and/or Cell DRX can be configured wherein a periodic cell DTX/DRX pattern is configured by a UE-specific RRC signalling message. Cell DTX and Cell DRX modes can be configured and operated separately (e.g., one RRC configuration set for DL and the other set for UL). UE specific DRX can be configured in a cell supporting Cell DTX and/or Cell DRX.

The periodic cell DTX pattern may be configured by a ‘duration’ and ‘period’ field wherein during the ‘duration’ interval which occurs periodically every ‘period’, the cell does not perform transmission (or stops certain transmissions (e.g., PDSCH, PBCH, SSBs, etc). Alternately, the periodic cell DTX pattern may be configured by a ‘duration’ and ‘period’ field wherein during the ‘duration’ interval which occurs periodically every ‘period’, the cell performs transmission and during the interval ‘period-duration’ the cell does not perform transmission (or stops certain transmissions (e.g., PDSCH, PBCH, SSBs, etc.)). The time interval where the cell does not perform transmission is referred as the non-active period of cell DTX. The time interval where the cell performs transmission is referred as the active period of cell DTX.

Periodic cell DRX pattern may be configured by a ‘duration’ and ‘period’ field wherein during the ‘duration’ interval which occurs periodically every ‘period’, the cell does not perform reception (or stops certain receptions e.g., PUCCH, PUSCH, PRACH etc). Alternately, the periodic cell DRX pattern may be configured by a ‘duration’ and ‘period’ field wherein during the ‘duration’ interval which occurs periodically every ‘period’, the cell performs reception and during the interval ‘period-duration’ the cell does not perform reception (or stops certain receptions e.g., PUCCH, PUSCH, PRACH etc). During the cell level DRX duration where the network (i.e., base station) does not receive transmission (or certain transmissions) from the UE on the uplink of that cell, the UE does not transmit (or does not transmit certain transmissions) in the uplink of that cell. The time interval where the cell does not perform reception is referred to as the non-active period of cell DRX. The time interval where the cell performs reception is referred as the active period of cell DRX.

A gNB can indicate to a UE via RRC signaling that the UE can transmit a scheduling request (SR) during the non-active period of cell DRX. This indication can be per SR configuration. Note that multiple SR configurations can be signaled to the UE by the GNB per cell group via RRC signaling.

If a SR is triggered during non-active period of cell DRX:
If for the SR configuration corresponding to the triggered SR, the gNB has indicated that the UE can transmit a scheduling request (SR) during the non-active period of cell DRX
   The UE transmits a SR in a PUCCH resource during the non-active period of cell DRX
   The UE monitors PDCCH for a new transmission during the non-active period of cell DTX
Otherwise
   The UE does not transmit a SR during the non-active period of cell DRX
   The UE does not monitor PDCCH for a new transmission during the non-active period of cell DTX

If a SR is triggered during the non-active period of cell DRX:
If for the SR configuration corresponding to triggered SR, the gNB has indicated that the UE can transmit a scheduling request (SR) during the non-active period of cell DRX
   The UE transmits the SR in a PUCCH resource during the non-active period of cell DRX
   The UE monitors PDCCH fora new transmission during the non-active period of cell DTX if the UE is in an active time of a UE specific DRX. (or the UE monitors PDCCH after the SR is sent on PUCCH and is pending irrespective of time while the SR is pending falls in the cell DTX active period or the cell DTX inactive period)
Otherwise
   The UE does not transmit a SR during the non-active period of cell DRX
   The UE does not monitor PDCCH for a new transmission during the non-active period of cell DTX

If SR is triggered during non-active period of cell DRX:
If for the SR configuration corresponding to the triggered SR, the gNB has indicated that the UE can transmit a scheduling request (SR) during the non-active period of cell DRX
   The UE transmits a SR in a PUCCH resource during the non-active period of cell DRX
   The UE monitors PDCCH for a new transmission or retransmission during the non-active period of cell DTX
Otherwise
   The UE does not transmit a SR during the non-active period of cell DRX
   The UE does not monitor PDCCH for a new transmission or retransmission during the non-active period of cell DTX

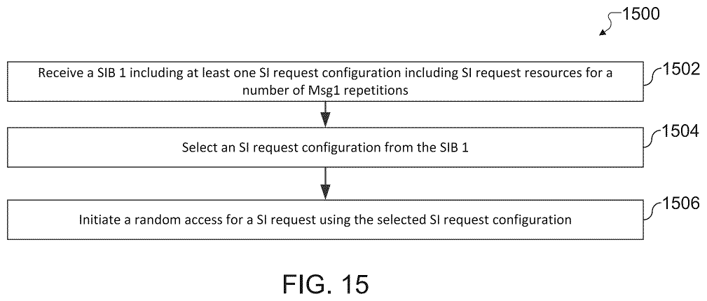

FIG. 15 illustrates a method 1500 for performing a system information request in a wireless network according to embodiments of the present disclosure. An embodiment of the method illustrated in FIG. 15 is for illustration only. One or more of the components illustrated in FIG. 15 may be implemented in specialized circuitry configured to perform the noted functions or one or more of the components may be implemented by one or more processors executing instructions to perform the noted functions. Other embodiments for performing a system information request in a wireless network could be used without departing from the scope of this disclosure.

The method 1500 begins at step 1502. At step 1502, a UE such as UE 116 of FIG. 1, receives a system information block 1 (SIB1) including at least one system information (SI) request configuration including SI request resources for a number of message 1 (Msg1) repetitions. At step 1504, the UE selects an SI request configuration from the SIB1. Finally, at step 1506, the UE initiates a random access for a SI request using the selected SI request configuration.

Although FIG. 15 illustrates one example of a method 1500 for performing a system information request in a wireless network, various changes may be made to FIG. 15. For example, while shown as a series of steps, various steps in FIG. 15 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver configured to receive a system information block 1 (SIB1) including at least one system information (SI) request configuration including SI request resources for a number of message 1 (Msg1) repetitions; and
a processor operatively coupled to the transceiver, the processor configured to:
select an SI request configuration from the SIB1, and
initiate a random access for a SI request using the selected SI request configuration.

2. The UE of claim 1, wherein the at least one SI request configuration comprises at least one of:
an SI request configuration for eight Msg1 repetitions for an initial uplink bandwidth part (BWP) of a normal uplink (NUL);
an SI request configuration for four Msg1 repetitions for the initial uplink BWP of the NUL;
an SI request configuration for two Msg1 repetitions for the initial uplink BWP of the NUL;
an SI request configuration for eight Msg1 repetitions for an initial uplink BWP of a supplementary uplink (SUL);
an SI request configuration for four Msg1 repetitions for the initial uplink BWP of the SUL;
an SI request configuration for two Msg1 repetitions for the initial uplink BWP of the SUL;
an SI request configuration for eight Msg1 repetitions for a RedCap specific initial uplink BWP of the NUL;
an SI request configuration for four Msg1 repetitions for the RedCap specific initial uplink BWP of the NUL; and
an SI request configuration for two Msg1 repetitions for the RedCap specific initial uplink BWP of the NUL.

3. The UE of claim 2, wherein the initial uplink BWP is configured by a field initialUplinkBWP in SIB1, and the RedCap specific initial uplink BWP is configured by a field initialUplinkBWP-RedCap in SIB1.

4. The UE of claim 1, wherein:
the processor is further configured to:
determine that criteria to select a supplementary uplink (SUL) is met,
determine that criteria for N Msg1 repetitions is met, and
determine that the SIB1 includes an SI request configuration for N Msg1 repetitions on a SUL; and
to select the SI request configuration from the SIB1, the processor is further configured to select the SI request configuration for N Msg1 repetitions of the SUL.

5. The UE of claim 1, wherein if the SIB1 does not include any SI request configuration for Msg1 repetitions of a supplementary uplink (SUL) or if criteria for Msg1 repetitions is not met:
the processor is further configured to:
determine that criteria to select a SUL is met,
determine that the SIB1 includes an SI request configuration for no Msg1 repetitions using the SUL; and
to select the SI request configuration from the SIB1, the processor is further configured to select the SI request configuration for no Msg1 repetitions of the SUL.

6. The UE of claim 1, wherein:
the UE is a reduced capability (RedCap) UE or an enhanced reduced capability (eRedCap) UE;
the processor is further configured to:
determine that criteria to select a normal uplink (NUL) is met,
determine that a RedCap specific initial uplink bandwidth part (BWP) is configured,
determine that criteria for N Msg1 repetitions is met, and
determine that the SIB1 includes an SI request configuration for N Msg1 repetitions on the RedCap specific initial BWP of the NUL; and
to select the SI request configuration from the SIB1, the processor is further configured to select the SI request configuration for N Msg1 repetitions on the RedCap specific initial uplink BWP of the NUL.

7. The UE of claim 1, wherein:
The UE is a reduced capability (RedCap) UE or an enhanced reduced capability (eRedCap) UE; and
if the SIB1 does not include any SI request configuration for Msg1 repetitions for a RedCap specific initial uplink BWP of a normal uplink (NUL) or if criteria for Msg1 repetitions is not met:
the processor is further configured to:
determine that the RedCap specific initial uplink BWP is configured, and
determine that the SIB1 includes an SI request configuration for no Msg1 repetitions on the RedCap specific initial uplink BWP of the NUL; and
to select the SI request configuration from the SIB1, the processor is further configured to select the SI request configuration for no Msg1 repetitions on the RedCap specific initial uplink BWP of the NUL.

8. The UE of claim 1, wherein:
the UE is a reduced capability (RedCap) UE or an enhanced reduced capability (eRedCap) UE; and
if a RedCap specific initial bandwidth part (BWP) is not configured:
the processor is further configured to:
determine that criteria to select a NUL is met,
determine that criteria for N Msg1 repetitions is met, and
determine that the SIB1 includes an SI request configuration for N Msg1 repetitions on an initial uplink BWP of the NUL; and
to select the SI request configuration from the SIB1, the processor is further configured to select the SI request configuration for N Msg1 repetitions on the initial uplink BWP of the NUL.

9. The UE of claim 1, wherein:
the UE is a neither a reduced capability (Redcap) UE nor an enhanced reduced capability (eRedCap) UE;
the processor is further configured to:
determine that criteria to select a normal uplink (NUL) is met,
determine that an initial uplink bandwidth part (BWP) of the NUL is configured,
determine that criteria for N Msg1 repetitions is met, and
determine that the SIB1 includes an SI request configuration for N Msg1 repetitions on the initial uplink BWP of the NUL; and
to select the SI request configuration from the SIB1, the processor is further configured to select the SI request configuration for N Msg1 repetitions on the initial uplink BWP of the NUL.

10. The UE of claim 1, wherein:
the UE is neither a reduced capability (RedCap) UE nor an enhanced reduced capability (eRedCap) UE;
if the SIB1 does not include any SI request configuration for Msg1 repetitions for initial uplink bandwidth part (BWP) of a normal uplink (NUL) or if criteria for Msg1 repetitions is not met:
the processor is further configured to:
determine that criteria to select the NUL is met,
determine that the initial uplink BWP of the NUL is configured, and
determine that the SIB1 includes an SI request configuration for no Msg1 repetitions on the initial uplink BWP of the NUL; and
to select the SI request configuration from the SIB1, the processor is further configured to select the SI request configuration for no Msg1 repetitions on the initial uplink BWP of the NUL.

11. A method of operating a user equipment (UE), the method comprising:
receiving a system information block 1 (SIB1) including at least one system information (SI) request configuration including SI request resources for a number of message 1 (Msg1) repetitions;
selecting an SI request configuration from the SIB1; and
initiating a random access for a SI request using the selected SI request configuration.

12. The method of claim 11, wherein the at least one SI request configuration comprises at least one of:
an SI request configuration for eight Msg1 repetitions for an initial uplink bandwidth part (BWP) of a normal uplink (NUL);
an SI request configuration for four Msg1 repetitions for the initial uplink BWP of the NUL;
an SI request configuration for two Msg1 repetitions for the initial uplink BWP of the NUL;
an SI request configuration for eight Msg1 repetitions for an initial uplink BWP of a supplementary uplink (SUL);
an SI request configuration for four Msg1 repetitions for the initial uplink BWP of the SUL;
an SI request configuration for two Msg1 repetitions for the initial uplink BWP of the SUL;
an SI request configuration for eight Msg1 repetitions for a RedCap specific initial uplink BWP of the NUL;
an SI request configuration for four Msg1 repetitions for the RedCap specific initial uplink BWP of the NUL; and
an SI request configuration for two Msg1 repetitions for the RedCap specific initial uplink BWP of the NUL.

13. The method of claim 12, wherein the initial uplink BWP is configured by a field initialUplinkBWP in SIB1, and the RedCap specific initial uplink BWP is configured by a field initialUplinkBWP-RedCap in SIB1.

14. The method of claim 11, further comprising:
determining that criteria to select a supplementary uplink (SUL) is met;
determining that criteria for N Msg1 repetitions is met; and
determining that the SIB1 includes an SI request configuration for N Msg1 repetitions on a SUL,
wherein selecting the SI request configuration from the SIB1 comprises selecting the SI request configuration for N Msg1 repetitions of the SUL.

15. The method of claim 11, wherein if the SIB1 does not include any SI request configuration for Msg1 repetitions of a supplementary uplink (SUL) or if criteria for Msg1 repetitions is not met, the method further comprises:
determining that criteria to select a SUL is met; and
determining that the SIB1 includes an SI request configuration for no Msg1 repetitions using the SUL,
wherein selecting the SI request configuration from the SIB1 comprises selecting the SI request configuration for no Msg1 repetitions of the SUL.

16. The method of claim 11, wherein:
the UE is a reduced capability (RedCap) UE or an enhanced reduced capability (eRedCap) UE;
the method further comprises:
determining that criteria to select a normal uplink (NUL) is met,
determining that a RedCap specific initial uplink bandwidth part (BWP) is configured,
determining that criteria for N Msg1 repetitions is met, and
determining that the SIB1 includes an SI request configuration for N Msg1 repetitions on the RedCap specific initial BWP of the NUL; and
selecting the SI request configuration from the SIB1 comprises selecting the SI request configuration for N Msg1 repetitions on the RedCap specific initial uplink BWP of the NUL.

17. The method of claim 11, wherein:
The UE is a reduced capability (RedCap) UE or an enhanced reduced capability (eRedCap) UE; and
if the SIB1 does not include any SI request configuration for Msg1 repetitions for a RedCap specific initial uplink BWP of a normal uplink (NUL) or if criteria for Msg1 repetitions is not met:
the method further comprises:
determining that the RedCap specific initial uplink BWP is configured, and
determining that the SIB1 includes an SI request configuration for no Msg1 repetitions on the RedCap specific initial uplink BWP of the NUL; and
selecting the SI request configuration from the SIB1 comprises selecting the SI request configuration for no Msg1 repetitions on the RedCap specific initial uplink BWP of the NUL.

18. The method of claim 11, wherein:
the UE is a reduced capability (RedCap) UE or an enhanced reduced capability (eRedCap) UE; and
if a RedCap specific initial bandwidth part (BWP) is not configured:
the method further comprises:
determining that criteria to select a NUL is met,
determining that criteria for N Msg1 repetitions is met, and
determining that the SIB1 includes an SI request configuration for N Msg1 repetitions on an initial uplink BWP of the NUL; and
selecting the SI request configuration from the SIB1 comprises selecting the SI request configuration for N Msg1 repetitions on the initial uplink BWP of the NUL.

19. The method of claim 11, wherein:
the UE is a neither a reduced capability (Redcap) UE nor an enhanced reduced capability (eRedCap) UE;
the method further comprises:
determining that criteria to select a normal uplink (NUL) is met,
determining that an initial uplink bandwidth part (BWP) of the NUL is configured,
determining that criteria for N Msg1 repetitions is met, and
determining that the SIB1 includes an SI request configuration for N Msg1 repetitions on the initial uplink BWP of the NUL; and
selecting the SI request configuration from the SIB1 comprises selecting the SI request configuration for N Msg1 repetitions on the initial uplink BWP of the NUL.

20. The method of claim 11, wherein:
the UE is neither a reduced capability (RedCap) UE nor an enhanced reduced capability (eRedCap) UE;
if the SIB1 does not include any SI request configuration for Msg1 repetitions for initial uplink bandwidth part (BWP) of a normal uplink (NUL) or if criteria for Msg1 repetitions is not met:
the method further includes:
determining that criteria to select the NUL is met,
determining that the initial uplink BWP of the NUL is configured, and
determining that the SIB1 includes an SI request configuration for no Msg1 repetitions on the initial uplink BWP of the NUL; and
selecting the SI request configuration from the SIB1 comprises selecting the SI request configuration for no Msg1 repetitions on the initial uplink BWP of the NUL.
